(19) United States
(12) Patent Application Publication
(10) Pub. No.: US 2026/0064064 A1
(43) Pub. Date: Mar. 5, 2026

(54) IMAGE FORMING APPARATUS

(71) Applicant: CANON KABUSHIKI KAISHA, Tokyo (JP)

(72) Inventors: Koichi Sekimizu, Shiga (JP); Takuro Mita, Kanagawa (JP)

(21) Appl. No.: 19/307,188

(22) Filed: Aug. 22, 2025

(30) Foreign Application Priority Data
Sep. 4, 2024 (JP) 2024-152771

(51) Int. Cl. G03G 15/00; G03G 15/16; G03G 21/10; G03G 21/12

(52) U.S. Cl. CPC G03G 15/55; G03G 15/161; G03G 21/105; G03G 21/12

(57) ABSTRACT

An image forming apparatus includes a main assembly including an image forming portion, a driving source, and a detecting portion and includes an exchange unit including a rotatable member, a first rotatable member, a second rotatable member, and an urging member. The detecting portion changes in state depending on movement of the first rotatable member. A detection pattern of a detection signal outputted by the detecting portion is different between a case where the first rotatable member is in a first position and a rotational load torque of the rotatable member is less than a predetermined value, a case where the first rotatable member is in a second position and the rotational load torque is less than the predetermined value, and a case where the first rotatable member is in the second position and the rotational load torque is the predetermined value or more.

### BACKGROUND

### Field of the Technology

The present disclosure relates to an image forming apparatus, such as a printer, a copying machine, a facsimile machine, or a multi-function machine having a plurality of functions of these functions, using an electrophotographic type or an electrostatic recording type.

### Description of the Related Art

In the image forming apparatus such as the printer using the electrophotographic type, waste toner remaining on an image bearing member after a toner image is transferred from the image bearing member onto a transfer-receiving member is removed from the image bearing member by a cleaning means and is collected in a waste toner collecting container. The waste toner collecting container is provided with a full state detecting means in order to prevent leakage-out of the waste toner in some instances.

The waste toner collecting container is exchange by an operator such as a user or a person in charge of service after the full state is detected. Further, when the exchange of the waste toner collecting container is detected, a detection state of the full state by the full state detecting means is reset, so that it becomes possible to perform an image forming operation.

In Japanese Laid-Open Patent Application (JP-A) No. 2009-265281, a constitution in which full state detection of the waste toner collecting container is made by detecting a rotational load of a stirring member for stirring the waste toner through rotation in the waste toner collecting container is disclosed. When mounting/demounting of the waste toner collecting container is detected after the full state of the waste toner collecting container is detected, the number of sheets for monitoring is set and count down thereof is started. When the full state is detected again until the number of the sheets for monitoring becomes zero, discrimination that the waste toner collecting container is not exchanged is made, and when the full state is not detected, discrimination that the waste toner collecting container is exchanged is made. By this, in the case where the waste toner collecting container is simply mounted or demounted without being exchanged, the full state is detected again before the number of sheets reaches the number of sheets for monitoring, and therefore, it is possible to reduce a possibility of erroneous detection about the exchange of the waste toner collecting container.

Further, in JP-A No. 2019-66597, the following constitution is disclosed. A transfer unit is provided with a detecting lever taking different attitudes between a transfer unit packed in an apparatus main assembly and a transfer unit for exchange. Further, during an initial operation of an image forming apparatus, whether or not the transfer unit is exchanged to a new article is discriminated depending on a detection result of the attitude of the detecting lever. By this, even in the case where the transfer unit reaches and end of a lifetime thereof earlier than a lifetime of the apparatus main assembly or even in the case where the transfer unit fails, exchange of the transfer unit to the new article is detected, so that the operation of the apparatus main assembly can be continued.

### SUMMARY

According to an aspect of the present disclosure, there is provided an image forming apparatus comprising: a main assembly including an image forming portion configured to form an image with toner, a driving source configured to generate a driving force, and a detecting portion capable of taking a first state and a second state and configured to output a detection signal depending on each of the first state and the second state; and an exchange unit detachably mountable to the main assembly and including: a rotatable member; a first rotatable member configured to be rotated by input of the driving force from the driving source thereto; a second rotatable member provided coaxially with the first rotatable member and configured to transmit the driving force toward the rotatable member by being rotated through transmission thereto the driving force by the first rotatable member; and an urging member configured to urge the first rotatable member against the second rotatable member along a rotational axis direction of the first rotatable member, wherein the first rotatable member is movable to a first position and a second position different in position thereof relative to the second rotatable member with respect to the rotational axis direction of the first rotatable member in interrelation with a position of the second rotatable member relative to the first rotatable member with respect to a rotational direction of the first rotatable member depending on a magnitude of a rotational load torque of the rotatable member, wherein the detecting portion changes in state between the first state and the second state depending on movement of the first rotatable member between the first position and the second position, and wherein a detection pattern of a detection signal outputted by the detecting portion in a predetermined period from a start of drive of the driving source in a state in which the exchange unit is mounted to the main assembly is different between a case where the first rotatable member is in the first position and the rotational load torque of the rotatable member is less than a predetermined value when the drive of the driving source is started, a case where the first rotatable member is in the second position and the rotational load torque of the rotatable member is less than the predetermined value when the drive of the driving source is started, and a case where the first rotatable member is in the second position and the rotational load torque of the rotatable member is the predetermined value or more when the drive of the driving source is started.

Features of the present disclosure will become apparent from the following description of embodiments with reference to the attached drawings. The following description of embodiments are described by way of example.

### BRIEF DESCRIPTION OF THE DRAWINGS

FIG. 1 is a sectional view showing a whole constitution of a printer.

FIG. 2 is a sectional view showing the printer in a state in which a door thereof is open.

FIG. 3 is a sectional view showing the printer in a state in which a fixing device is moved.

FIG. 4 is a sectional view showing the printer in a state in which a transfer unit and a tray unit are pulled out.

FIG. 5 is a sectional view showing the printer in a state in which the transfer unit is solely pulled out.

FIG. 6 is a perspective view showing a whole constitution of the transfer unit.

FIG. 7 is a perspective view of the transfer unit for illustrating a waste toner conveying path.

FIG. 8 is a perspective view showing the waste toner conveying path and a drive connection mechanism.

FIG. 9 is a perspective view of the drive connection mechanism in an embodiment 1.

FIG. 10 is an exploded perspective view of the drive connection mechanism in the embodiment 1.

Parts (a) to (b) of FIG. 11 are a perspective view and a front view, respectively, of a movable gear in the embodiment 1, and parts (c) and (d) of FIG. 11 are a perspective view and a front view, respectively, of a fixed gear in the embodiment 1.

Parts (a), (b), and (c) of FIG. 12 are schematic views for illustrating an operation of the drive connection mechanism in the embodiment 1.

Parts (a) and (b) of FIG. 13 are perspective views for illustrating an operation of a detecting mechanism.

Parts (a) and (b) of FIG. 14 are sectional views for illustrating the operation of the detecting mechanism.

Parts (a) and (b) of FIG. 15 are time charts each showing a detection pattern during detection of a near full state in the embodiment 1.

FIG. 16 is a flowchart of the detection of the near full state.

Parts (a) to (c) of FIG. 17 are schematic views for illustrating an operation of the drive connection mechanism during detection of exchange to a new article in the embodiment 1.

FIG. 18 is a flowchart of the detection of the exchange to the new article in the embodiment 1.

Parts (a) to (c) of FIG. 19 are time charts each showing a detection pattern during the detection of the exchange to the new article in the embodiment 1.

Parts (a) and (b) of FIG. 20 are a perspective view and a front view, respectively, of a movable gear in an embodiment 2, and parts (c) and (d) of

FIG. 20 are a perspective view and a front view, respectively, of a fixed gear in the embodiment 2.

Parts (a) to (d) of FIG. 21 are schematic views for illustrating an operation of a drive mechanism during detection of a near full state in the embodiment 2.

Parts (a) and (b) of FIG. 22 are perspective views for illustrating an operation of a detecting mechanism.

Parts (a) and (b) of FIG. 23 are time charts each showing a detection pattern during the detection of the near full state in the embodiment 2.

FIG. 24 is a flowchart of the detection of the near full state in the embodiment 2.

Parts (a) to (c) of FIG. 25 are schematic views for illustrating an operation of the drive connection mechanism during detection of exchange to a new article in the embodiment 2.

Parts (a) and (b) of FIG. 26 are time charts each showing a detection pattern during the detection of the exchange to the new article in the embodiment 2.

FIG. 27 is a flowchart of the detection of the exchange to the new article in the embodiment 2.

FIG. 28 is a block diagram showing a schematic control constitution of the printer.

### DESCRIPTION OF THE EMBODIMENTS

In the following, an image forming apparatus according to the present disclosure will be described specifically.

### Embodiment 1

### <Whole Constitution of Image Forming Apparatus>

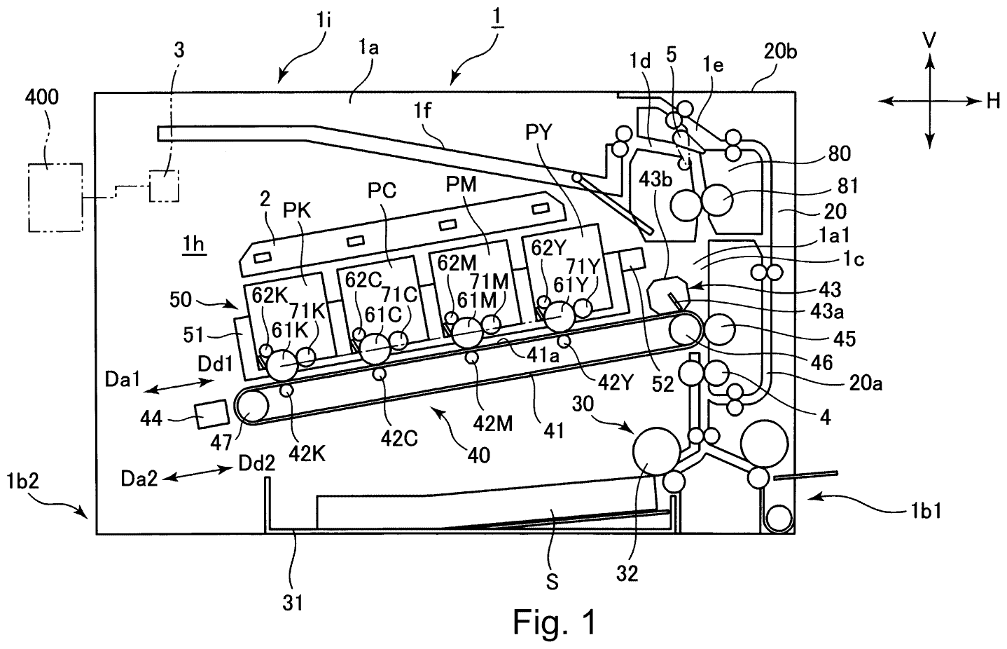

A whole constitutions of the image forming apparatus of this embodiment will be described using FIG. 1. FIG. 1 is a sectional view showing the whole constitution of the image forming apparatus of this embodiment. In this embodiment, the image forming apparatus is a tandem-type color laser beam printer (hereinafter, simply referred to as a “printer”) 1 employing an intermediary transfer type in which a full-color image is capable of being formed on a sheet S by using an electrophotographic type.

Incidentally, as regards the printer 1 and elements thereof, a right side in FIG. 1 is a “front (front surface)” side, and a left side in FIG. 1 is a “rear (rear side)” side. Further, as regards the printer 1 and the elements thereof, in the case where the printer 1 is viewed from the front side, a left side (the front side on the drawing sheet of FIG. 1) is a “left” side, and a right side (the rear side on the drawing sheet of FIG. 1) is a “right” side. A left-right direction connecting these left side and right side is substantially parallel to a rotational axis direction of a photosensitive drum 61 described later and is substantially parallel to a rotational axis direction of each of stretching rollers for an intermediary transfer belt 41 described later. Further, in this embodiment, the printer 1 is disposed so that a front-rear direction and a left-right direction are substantially parallel to a horizontal direction H, and is used for image formation. Further, as regards the printer 1 and the elements thereof, up (upper) and drum (lower) refer to up (upper) and down (lower) in a gravitational direction (vertical direction) V, but do not mean only immediately above (on) and immediately below (under), and include an upper side and a lower side than a horizontal surface (plane) passing through a noting position or a noting element. Further, as the sheet S, typically, paper is used, and therefore, the sheet S is referred to as the paper in some instances, but the surface S is not limited to the paper, and as the sheet S, a material, other than the paper, such as a plastic sheet, or a sheet formed of a material including the material other than the paper can also be used.

The printer 1 includes an apparatus main assembly (casing) 1a, a scanner 2 which is an exposure device as an exposure means, a controller (control circuit) 3 as a control means, and a door 20 which is an openable/closable member which is openable and closable relative to the apparatus main assembly 1a. Further, the printer 1 includes a sheet feeding portion 30, a transfer unit 40 which is a transfer device (intermediary transfer device) as a transfer means, a tray unit 50 as a moving unit (supporting unit), and a fixing device 80 as a fixing means. A portion including the apparatus main assembly 1a and the door 20 can also be referred to as a main frame 1i. The main frame 1i includes an outer casing portion of the printer 1.

The apparatus main assembly 1a accommodates the scanner 2, the controller 3, the sheet feeding portion 30, the transfer unit 40, the tray unit 50, and the fixing device 80.

The sheet feeding portion 30 includes a stacking tray 31 on which sheets S which are sheet-like recording materials (transfer materials, recording media, sheets) are stacked, and a feeding roller 32 as a feeding member. The stacking tray 31 is capable of being pulled out in a drive (front side) from the apparatus main assembly 1a to the door 20. Further, to the stacking tray 31 pulled out from the apparatus main assembly 1a, sheets S can be supplemented.

The tray unit 50 includes a tray 51 as a supporting member (drawer), and four cartridges (image forming portions) PY, PM, PC, and PK. The tray 51 includes a tray handle 52. Each of the cartridges PY, PM, PC, and PK is detachably (removably) mounted to the tray 51.

In this embodiment, each of the cartridges PY, PM, PC, and PK is independently detachably mountable to the tray 51. The four cartridges PY, PM, PC, and PK form images (toner images) of yellow (Y), magenta (M), cyan (C), and black (K), respectively.

The four cartridges PY, PM, PC, and PK accommodate toner as developers of yellow (Y), magenta (M), cyan (C) and black (K), respectively. In this embodiment, as each of the developers, a one-component developer is used. The cartridges PY, PM, PC, and PK have substantially the same constitution except that the colors of the toner accommodated therein are different from each other. As regards elements having identical or corresponding functions or constitutions provided for the respective colors of yellow, magenta, cyan, and black, these elements are collectively described in some instances by omitting suffixes Y, M, C, and K, of reference numerals or symbols, each showing the element for the associated one of the colors. The tray unit 50 can be said to include the plurality of the cartridges P, and the tray 51 to which the plurality of the cartridges P are detachably mounted.

In this embodiment, the tray unit 50 includes the plurality of photosensitive drums 61 (61Y, 61M, 61C, 61K), a plurality of charging rollers 62 (62Y, 62M, 62C, 62K), and a plurality of developing rollers 71 (71Y, 71M, 71C, 71K). Specifically, the tray unit 50 includes four photosensitive drums 61, four charging rollers 62, and four developing rollers 71. The photosensitive drum 61 is a rotatable drum-type (cylindrical) photosensitive member (electrophotographic photosensitive member) as a first image bearing member.

The charging roller 62 is a roller-type charging member as a charging means.

The developing roller 71 is a developer carrying member (developing member) for carrying and conveying, toward the photosensitive drum 61, toner accommodated in a toner accommodating member provided in the tray 51 or the cartridge P. A rotational axis direction of the photosensitive drum 61, a rotational axis direction of the developing roller 71, and a rotational axis direction of the charging roller 62 are substantially parallel to each other.

A portion (including the photosensitive drum 61, the charging roller 62, and the developing roller 71) forming an image of the associated color can also be referred to as a station. The cartridge PK for black is mounted to a black station. The cartridge PC for cyan is mounted to a cyan station. The cartridge PM for magenta is mounted to a magenta station. The cartridge PY for yellow is mounted to a yellow station.

The photosensitive drum 61, the charging roller 62, and the developing roller 71 may only be required to be provided in either one of the cartridge P or the tray 51. In this embodiment, the cartridge P includes the photosensitive drum 61, the charging roller 62, and the developing roller 71. Incidentally, the tray unit 50 may include a drum cleaning portion (drum cleaning device) as a photosensitive member cleaning means for removing the toner from the associated one of the photosensitive drums 61. That is, the tray unit 50 may include a plurality of drum cleaning portions for cleaning surfaces of the photosensitive drums 61, respectively. The drum cleaning portion can be provided to either one of the cartridge P and the tray 51. For example, the drum cleaning portion scrapes off the toner from the surface of the rotating photosensitive drum 61 by a cleaning blade as a cleaning member contacting the surface of the photosensitive drum 61, and accommodates the toner in a collected toner accommodating portion provided to the tray 51 or the cartridge P.

The transfer unit 40 includes the intermediary transfer belt (hereinafter, simply referred to as a “belt”) 41, primary transfer rollers 42 (42Y, 42M, 42C, 42K), a cleaning portion 43, a driving roller 46, and a tension roller (driven roller, follower roller) 47. The belt 41 is an intermediary transfer member constituted by an endless belt as a second image bearing member. The primary transfer roller 42 is a roller-type primary transfer member as a primary transfer means. The cleaning portion (belt cleaning device) 43 is a cleaning means for cleaning a surface of the belt 41. The driving roller 46 and the tension roller 47 are stretching rollers for stretching the belt 41. The driving roller 46 drives the belt 41. Further, the tension roller 47 imparts a predetermined tension to the belt 41. By the driving roller 46 and the tension roller 47, a primary transfer surface 41a which is a surface of the belt 41 onto which toner images are transferred from the photosensitive drums 61Y, 61M, 61C, and 61K is formed.

In this embodiment, the printer 1 includes an optical sensor 44 for detecting the toner image transferred on the belt 41. In this embodiment, the belt 41 is disposed below the photosensitive drums 61Y, 61M, 61C, and 61K. The belt 41 is contactable to the photosensitive drum 61 so that a primary transfer portion is formed between the belt 41 and the photosensitive drum 61. Further, the printer 1 includes a secondary transfer roller 45 in a position where the secondary transfer roller 45 opposes the driving roller 46 through the belt 41. The secondary transfer roller 45 contacts the belt 41 so that a secondary transfer portion is formed between the belt 41 and the secondary transfer roller 45. A rotational axis direction of the primary transfer roller 42, a rotational axis direction of the driving roller 46, a rotational axis direction of the tension roller 47, and a rotational axis direction of the secondary transfer roller 45 are substantially parallel to each other. On a front side of the secondary transfer portion with respect to the conveying direction of the sheet S, a registration roller pair 4 as a synchronous conveying member is provided.

The fixing device 80 includes a fixing portion 81 and a flapper 5. When an image forming operation for forming an image on the sheet S, the fixing device 80 is in a use position. The fixing device 80 is accommodated in an inside portion of (inside) the apparatus main assembly 1a in a state in which the fixing device 80 is in the use position. Further, the fixing device 80 is constituted so as to heat the sheet S in the state in which the fixing device 80 is in the use position. In this embodiment, the fixing portion 81 includes a heating portion (heating roller) including a heater, and a pressing portion (pressing roller) for nipping and conveying the sheet S in cooperation with the heating portion.

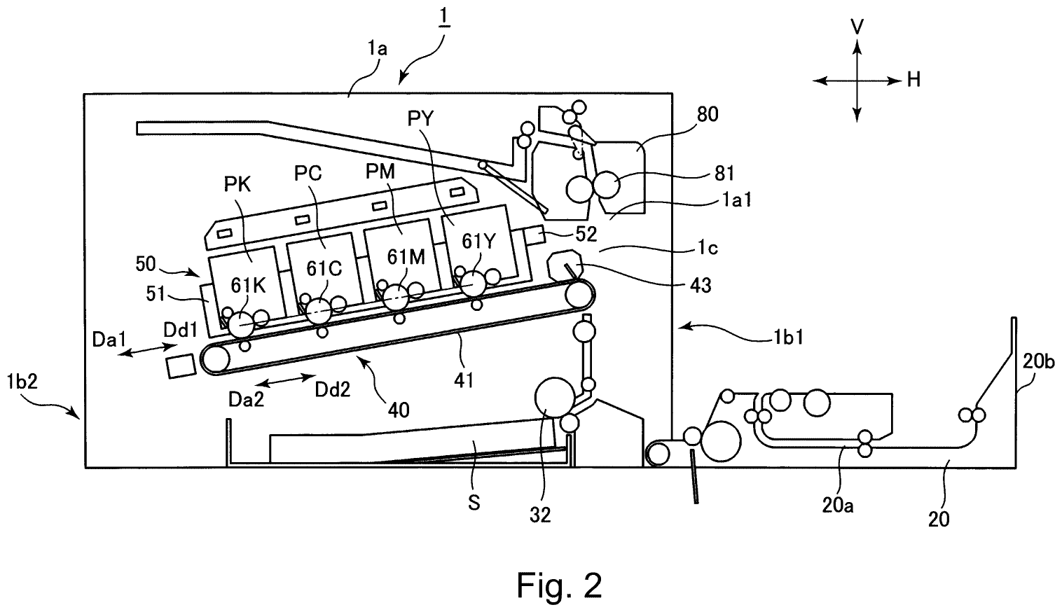

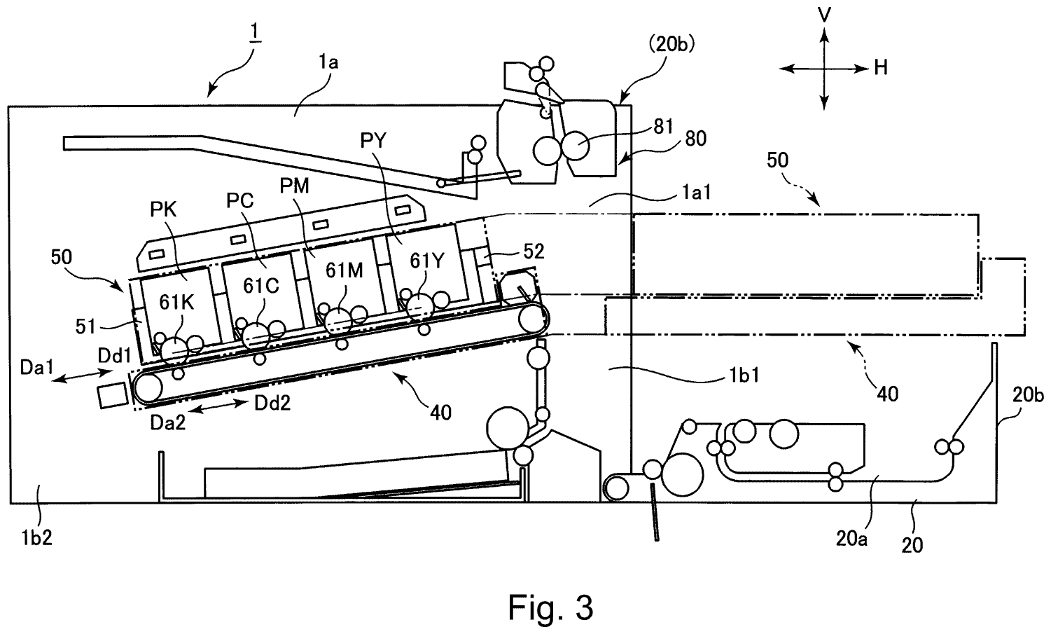

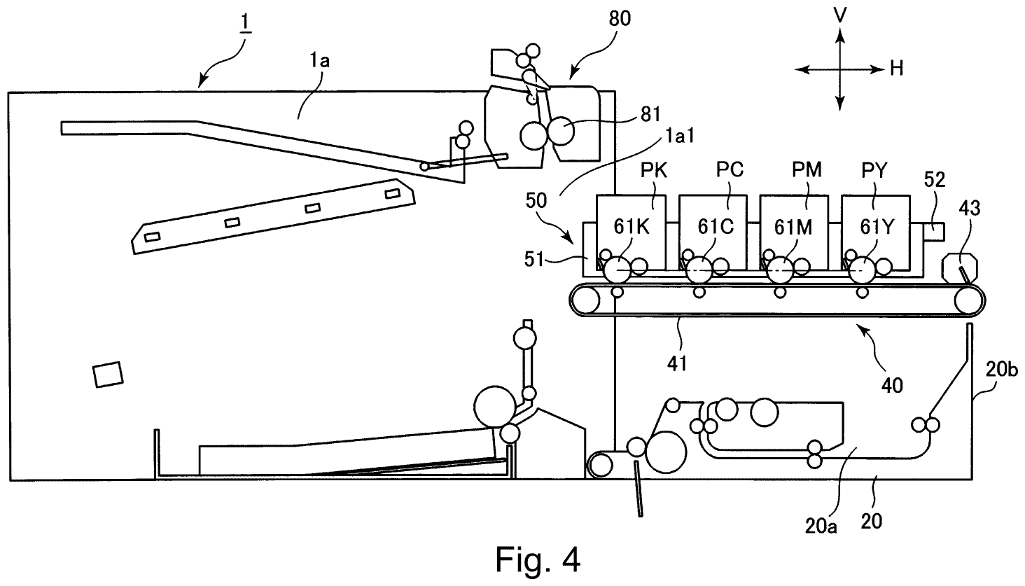

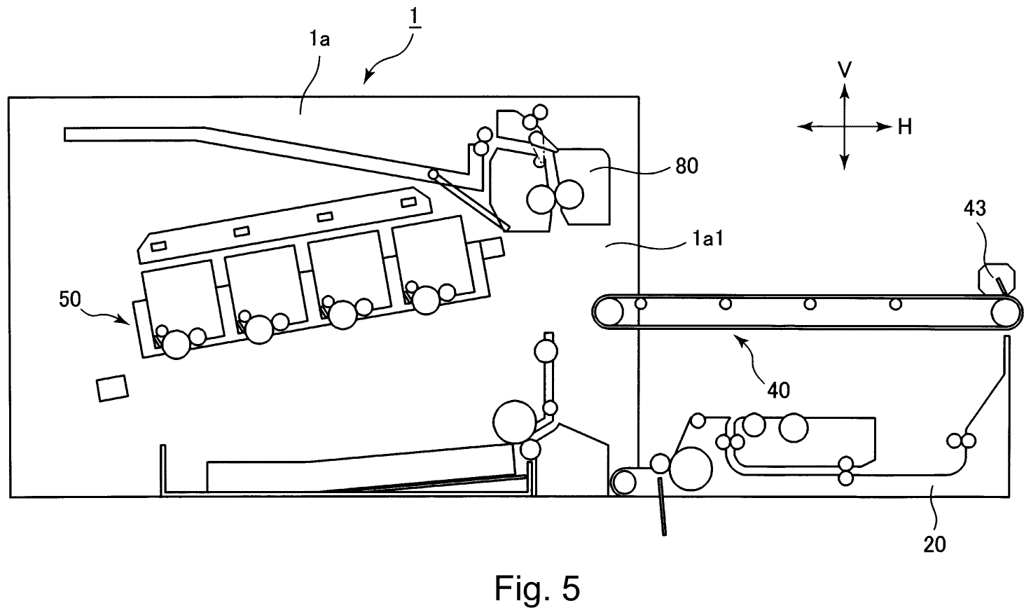

Movement of the transfer unit 40 and the tray unit 50 will be described by using FIGS. 1 to 5. FIG. 2 is a sectional view showing the printer 1 in a state in which the door 20 is open. FIG. 3 is a sectional view showing the printer 1 in a state in which the fixing device 80 is moved. FIG. 4 is a sectional view showing the printer 1 in a state in which the transfer unit 40 and the tray unit 50 are pulled out from the apparatus main assembly 1a. FIG. 5 is a sectional view showing the printer 1 in a state in which the transfer unit 40 is solely pulled out from the apparatus main assembly 1a.

The transfer unit 40 and the tray unit 50 are movable from an inside to an outside of the apparatus main assembly 1a. With respect to the horizontal direction H (front-rear direction), the apparatus main assembly 1a includes a first end portion 1b1 provided with a main assembly opening 1a1 which is an opening, and a second end portion 1b2 on a side opposite from the first end portion 1b1.

The tray unit 50 is movable, through the main assembly opening 1a1, between a first inside position on the inside of the apparatus main assembly 1a and a first outside position on the outside of the apparatus main assembly 1a. The transfer unit 40 is movable, through the main assembly opening 1a1, between a second inside position on the inside of the apparatus main assembly 1a and a second outside position on the outside of the apparatus main assembly 1a. The main assembly opening 1a1 may also be constituted by including an opening through which the tray unit 50 passes and an opening through which the transfer unit 40 passes. Incidentally, when the transfer unit 40 moves from the second inside position to the second outside position, at least the belt 41 is moved and at least a part of the belt 41 projects from the apparatus main assembly 1a toward the outside of the apparatus main assembly 1a.

A direction in which tray unit 50 moves from the first inside position to the first outside position is referred to as a tray demounting direction Dd1, and a direction opposite to the tray demounting direction Dd1 is referred to as a tray mounting (attaching) direction Da1. The tray demounting direction Dd1 can be said as a direction from the second end portion 1b2 toward the first end portion 1b1. A direction in which the transfer unit 40 moves from the second inside position to the second outside position is referred to as a transfer (unit) demounting direction Dd2, and a direction opposite to the transfer demounting direction Dd2 is referred to as a transfer (unit) mounting (attaching) direction Da2. With respect to the transfer demounting direction Dd2, the driving roller 46 is positioned on a side downstream of the tension roller 47. The transfer demounting direction Dd2 can be said as a direction from the second end portion 1b2 toward the first end portion 1b1. Each of the tray demounting direction Dd1 and the tray mounting direction Da1 is a direction crossing (preferably substantially perpendicular to) the rotational axis direction of the photosensitive drum 61. Each of the transfer demounting direction Dd2 and the transfer mounting direction Da2 is a direction crossing (preferably substantially perpendicular to) the rotational axis direction of the driving roller 46. The rotational axis direction of the driving roller 46 is substantially parallel to the rotational axis direction of the photosensitive drum 61. In the horizontal direction H (front-rear direction), on one end side of the apparatus main assembly 1a (on a side where the first end portion 1b1 is disposed), the fixing device 80 is disposed.

The door 20 mounted to the apparatus main assembly 1a is movable between a closed position and an open position.

As shown in FIG. 1, in a state in which the door 20 is in the closed position (closed state of the door 20), the door 20 covers the main assembly opening 1a1. As shown in FIG. 2, in a state in which the door 20 is in the open position (open state of the door 20), the main assembly opening 1a1 is exposed.

As shown in FIG. 1, in the state in which the door 20 is in the closed position, the door 20 covers the fixing device 80 mounted to the apparatus main assembly 1a. Specifically, in the state in which the door 20 is in the closed position, an upper cover portion 20b of the door 20 is positioned above the fixing device 80. The upper cover portion 20b of the door 20 has a function as a part of an outer casing portion of the printer 1.

The door 20 is capable of moving to the open position and the closed position in a state in which the fixing device 80 is supported by the apparatus main assembly 1a. In other words, the door 20 moves from the closed position to the open position so as to be separated from the fixing device 80 supported by the apparatus main assembly 1a. Accordingly, as shown in FIG. 2, in the state in which the door 20 is in the open position, the door 20 is separated from the fixing device 80 supported by the apparatus main assembly 1a.

As described above, the fixing device 80 is movable from a state shown in FIG. 2 to a state shown in FIG. 3 so that the main assembly opening 1a1 is widely exposed. As shown in FIG. 3, in a state in which the door 20 and the fixing device 80 are moved, the transfer unit 40 and the tray unit 50 are movable from the inside to the outside of the apparatus main assembly 1a through the main assembly opening 1a1, and become a state shown in FIG. 4 after being moved.

As shown in FIG. 4, in a state in which the tray unit 50 is moved to the outside of the apparatus main assembly 1a, demounting of each of the cartridges PY, PM, PC, and PK from the tray 51 and mounting of each of the cartridges PY, PM, PC, and PK to the tray 51 are permitted. By this, the cartridges PY, PM, PC, and PK can be exchanged with new cartridges PY, PM, PC, and PK, respectively. In this embodiment, the cartridge P is detachably mountable to the tray 51 with respect to a direction crossing (preferably substantially perpendicular to) the rotational axis direction of the photosensitive drum 61.

Each of the cartridges PY, PM, PC, and PK is demounted from the tray 51 by being moved relative to the tray 51 in a direction in which each cartridge is moved away from the transfer unit 40. In other words, each of the cartridges PY, PM, PC, and PK is demounted from the tray 51 by being moved toward a side opposite from the transfer unit 40 with respect to the tray 51. In this embodiment, the transfer unit 40 is disposed below the tray unit 50. Accordingly, each of the cartridges PY, PM, PC, and PK is demounted from the tray 51 by being moved upward relative to the tray 51.

Further, as shown in FIG. 5, the transfer unit 40 can be demounted from the apparatus main assembly 1a independently of the tray unit 50. By this, the transfer unit 40 can be exchanged with a new transfer unit 40.

### <Image Forming Operation>

An image forming operation of the printer 1 will be described by using FIG. 1. A controller 3 of the printer 1 starts the image forming operation for forming the image on the sheet S on the basis of image information (image signal) received from an external host device 400. The external host device 400 is, for example, a personal computer, an image reader, a facsimile machine, or the like.

When the image forming operation is performed, the fixing device 80 is positioned in the use position, the tray unit 50 is positioned in the first inside position, the transfer unit 40 is positioned in the second inside position, and the door 20 is positioned in the closed position. In a state in which the transfer unit 40 is in the second inside position, the belt 41 is contactable to the photosensitive drums 61Y, 61M, 61C, and 61K. At this time, the tray unit 50 is positioned above the transfer unit 40.

When the image forming operation is started, the photosensitive drum 61 is rotationally driven, and to the charging roller 62, a charging voltage is applied. The photosensitive drum 61 is rotationally driven in a clockwise direction in FIG. 1. Further, the belt 41 is rotationally driven. The belt 41 is rotated (circulated and moved) in a counterclockwise direction in FIG. 1 by that the driving roller 46 is rotationally driven by a driving motor 5 (FIG. 28). The surface of the photosensitive drum 61 is electrically charged uniformly to a predetermined polarity (negative polarity in this embodiment) and a predetermined potential by the charging roller 62. The charged surface of the photosensitive drum 61 is irradiated with laser light, corresponding to the image information, from the scanner 2, so that the surface of the photosensitive drum 61 is exposed to the laser light. By this, on the surface of the photosensitive drum 61, an electrostatic latent image (electrostatic image) corresponding to the image information is formed.

The developing roller 71 carries thereon the toner in the toner accommodating portion provided in the cartridge P in this embodiment. To the developing roller 71, a developing voltage is applied, so that the toner is supplied from the developing roller 71 to the surface of the photosensitive drum 61 depending on the electrostatic latent image formed on the surface of the photosensitive drum 61.

By this, the electrostatic latent image on the surface of the photosensitive drum 61 is developed (visualized), so that a toner image (toner picture, developer image) is formed on the surface of the photosensitive drum 61. In this embodiment, on an exposure portion of the photosensitive drum 61 lowered in absolute value of an electric charge by that the surface of the photosensitive drum 61 is exposed to the laser light after being charged uniformly, toner charged to the same polarity (negative polarity in this embodiment) as a charge polarity of the photosensitive drum 61 is deposited. In this embodiment, a normal charge polarity of the toner, which is a principal charge polarity of the toner during development is the negative polarity. In this embodiment, the developing roller 71 develops the electrostatic latent image in a state in which the developing roller 71 contacts the photosensitive drum 61.

However, the printer 1 may have a constitution in which the developing roller 71 develops the electrostatic latent image in a state in which there is a gap between the developing roller 71 and the photosensitive drum 61.

For example, during full-color image formation, toner images of the colors of yellow, magenta, cyan, and black are formed on the photosensitive drums 61Y, 61M, 61C, and 61K, respectively.

Incidentally, in this embodiment, in a state in which the tray unit 50 is in the first inside position, the developing roller 71 is movable between a contact position where the developing roller 71 contacts the photosensitive drum 61 and a separation position where the developing roller 71 is separated from the photosensitive drum 61. Specifically, by a switching device (not shown) provided in the apparatus main assembly 1a, a state in which the developing roller 71 is in the contact position and a state in which the developing roller 71 is in the separation position are switched therebetween. By this, in a state in which the image forming operation is not performed, the developing roller 71 can be kept separated from the photosensitive drum 61.

Further, the printer 1 is capable of performing monochromatic print (printing) in a state in which the developing roller 71 and the photosensitive drum 61 of the cartridge PK are in contact with each other and in which the developing roller 71 and the photosensitive drum 61 of each of the cartridges PY, PM, and PK are in separation from each other. Further, the printer 1 is capable of performing full-color print (printing) in a state in which the photosensitive drums 61 of the cartridges PY, PM, PC, and PK and the belt 41 are in contact with each other.

The toner image formed on the photosensitive drum 61 is transferred (primarily) transferred onto the rotating belt 41 as a transfer-receiving member in the primary transfer portion by the action of the primary transfer roller 42. During the primary transfer, to the primary transfer roller 42, a primary transfer voltage of the opposite polarity to the normal charge polarity of the toner is applied. The toner image transferred on the belt 41 is conveyed toward a secondary transfer portion formed by the belt 41 and the secondary transfer roller 45, by rotation of the belt 41. For example, during the full-color image formation, the toner images of the colors of yellow, magenta, cyan, and black formed on the photosensitive drums 61Y, 61M, 61C, and 61K are successively transferred superposedly in the same image forming region on the belt 41.

On the other hand, in the apparatus main assembly 1a, a conveying path (first path, first conveying path) 1c along which the sheet S directed toward the fixing device 80 passes is formed. Further, on the door 20, a double-side conveying path (second path, second conveying path) 20a along which the sheet S moving toward the fixing device 80 passes is formed. The door 20 covers the conveying path 1c in the closed state. As shown in FIG. 2, the door 20 is opened, so that the conveying path 1c and the double-side conveying path 20a are exposed. In the sheet feeding portion 30, from the sheets S stacked on the stacking tray 31, at a predetermined timing, one sheet S is separated and fed by the feeding roller 32. This sheet S passes through the conveying path 1c and is conveyed toward the secondary transfer portion and the fixing device 80. That is, the sheet S fed from the stacking tray 31 by the feeding roller 32 is conveyed to the registration roller pair 4. This sheet 4 is conveyed toward the secondary transfer portion by being timed to the toner images on the belt 41, by the registration roller pair 4.

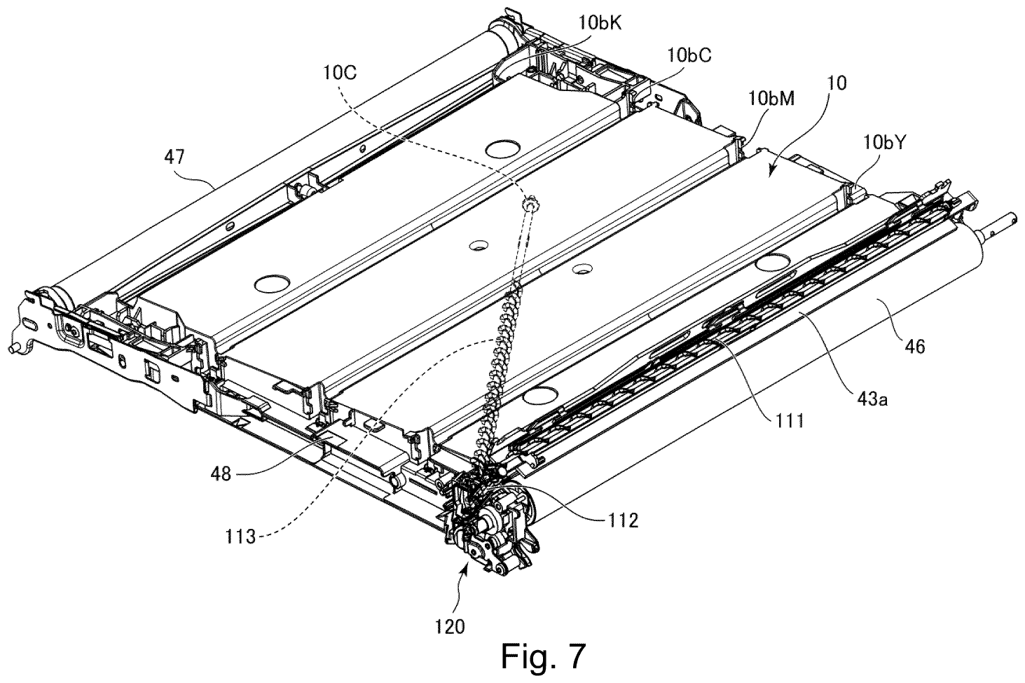

The toner images formed on the belt 41 are transferred (secondarily transferred) in the secondary transfer portion onto the sheet S nipped and conveyed by the belt 41 and the secondary transfer roller 45 by the action of the secondary transfer roller 45. During the secondary transfer, to the secondary transfer roller 45, a secondary transfer voltage of the opposite polarity to the normal charge polarity of the toner is applied. Toner (waste toner, remaining toner) remaining on the belt 41 without being transferred onto the sheet S is removed and collected from on the belt 41 by the cleaning portion 43. The cleaning portion 43 includes a cleaning blade 43a as a cleaning member contacting the surface of the belt 41 and a cleaning container 43b forming a collected toner accommodating portion. The cleaning blade 43a is provided in the cleaning container 43b. The cleaning portion 43 scrapes off the toner from the surface of the rotating belt 41 by the cleaning blade 43a, and accommodates the toner in the cleaning container 43b. The toner removed from the surface of the belt 41 by the cleaning portion 43 is collected (accumulated) as residual (waste) toner by being conveyed from the cleaning portion 43 toward a waste toner collecting container 10 (FIG. 7) described later.

The sheet S on which the toner images are transferred in the secondary transfer portion is conveyed toward the fixing device 80. The fixing portion 81 of the fixing device 80 heats and presses the sheet S on which unfixed toner images are carried, and fixes (melts, sticks) the toner images on the sheet S. The sheet S on which the toner images are fixed is conveyed toward a flapper 5 as a path switching portion.

The flapper 5 is movable to a discharge position where the sheet S passed through the fixing device 80 is guided toward a discharge path 1d, and a reverse roller where the sheet S is guided toward a reverse path 1e. In the case where one-side print (printing) in which the image is formed on one surface (side) of the sheet S is performed, the sheet S is guided to the discharge path 1d by the flapper 5 and is discharged (outputted) to a discharge tray 1f formed at an upper portion of the apparatus main assembly 1a. On the other hand, in the case where double-side print (printing) in which images are printed (formed) on a first surface (side) (front surface (side)) and a second surface (side) (rear surface (side)) of the sheet S, the sheet S on which first surface the toner image is fixed is guided to the reverse path 1e by the flapper 5. This sheet S is reversed in conveying direction thereof after being guided to the reverse path 1e. Then, the sheet S passes through the double-side conveying path 20a formed on the door 20 and is conveyed toward the secondary transfer portion, and then, the toner image is transferred onto the second surface. Thereafter, this sheet S passes through the fixing device 80 and is guided to the discharge path 1d by the flapper 5, and then is discharged to the discharge tray 1f of the apparatus main assembly 1a.

In this embodiment, an image forming portion 1h for forming the toner image on the sheet S is constituted by the image forming portions P, the transfer unit 40, the secondary transfer roller 45, and the like. Further, in this embodiment, the cleaning portion 43 of the belt 41 is an example of the cleaning portion for collecting the toner in the image forming portion 1h. Further, in this embodiment, the waste toner collecting container 10 (FIG. 7), for accommodating the toner collected from the belt 41, described later is an example of a waste toner collecting container 10 for accommodating toner collected by the cleaning portion (waste toner collected in the apparatus main assembly).

### <Control Constitution>

FIG. 28 is a block diagram showing a schematic control constitution of the printer 1. The printer 1 includes the controller 3 as a control means for integrally controlling the printer 1. The controller 3 is constituted by including a CPU 3a as an arithmetic processing means (arithmetic processing portion), a memory 3b as a storing means (storing portion) and an input/output circuit (not shown) as an input/output means (input/output portion). The memory 3b is constituted by including a ROM, a RAM, and an EEPROM. In the ROM, a control program and an application program which are executed by the CPU 3a are stored. The RAM functions as a work area for executing processing of the control program. The EEPROM holds data such as various settings desired to be held even when a power source of the printer 1 is turned off. The CPU 3a carries out control of the printer 1 in accordance with the program stored in the memory 3b (ROM).

To the controller 3, for example, a detecting mechanism 100 described later, an operating portion 4, the driving motor 5, the scanner 2, a high-voltage power source 6, and the like are connected. The detecting mechanism is, as described later, capable of detecting movement of a movable gear 121 in a rotational axis direction in a drive transmission mechanism 120 for driving a waste toner conveying screw 113 provided to the waste toner collecting container 10. Further, as a result, the detecting mechanism 100 is capable of detecting that a rotational load torque of the waste toner conveying screw 113 becomes a predetermined value or more (overload state) as described later. The detecting mechanism 100 inputs, to the controller 3, a signal indicating a detection result thereof. The operating portion 4 is constituted by including a display portion for displaying information to a user (operator) by control of the controller 3 and an input portion for inputting, to the controller 3, in formation such as various settings on the basis of an operation by the user. The operating portion 3 may be constituted by including a touch panel or the like having a function of the display portion and a function of the input portion. In this case, the operating portion 4 performs screen display to the user and reception of touch input by the user. The driving motor 5 is a driving source for generating a driving force for rotationally driving the belt 41 (driving roller 46). Incidentally, the printer 1 may also be provided with another driving motor as a driving source for another driven portion such as the photosensitive drum 61 or the fixing device 80. Further, the driving source for the driving roller 46 as the driven portion and at least a part of the driving source for another driven portion such as the photosensitive drum 61 or the fixing device 80 may also be commonized. The high-voltage power source 6 applies predetermined voltages to the charging roller 62, the developing roller 71, the primary transfer rollers 42, the secondary transfer roller 45, and the like. For each of application objects, a separate high-voltage power source 6 may be provided, and commonality of high-voltage power sources 6 for a plurality of application objects of the above-described application objects may also be realized. Further, to the controller 3, the external host device 400 is connected. The controller 3 is capable of executing the image forming operation by controlling the respective portions of the printer 1 on the basis of a print instruction or image information inputted from the external host device 400.

Further, the controller 3 is capable of executing processing of detection and notification of a near full state or a full state of the waste toner collecting container 10, and processing of detection of exchange to a new article of the waste toner collecting container 10 (transfer unit 40) as described later.

### <Residual Toner Conveying Path>

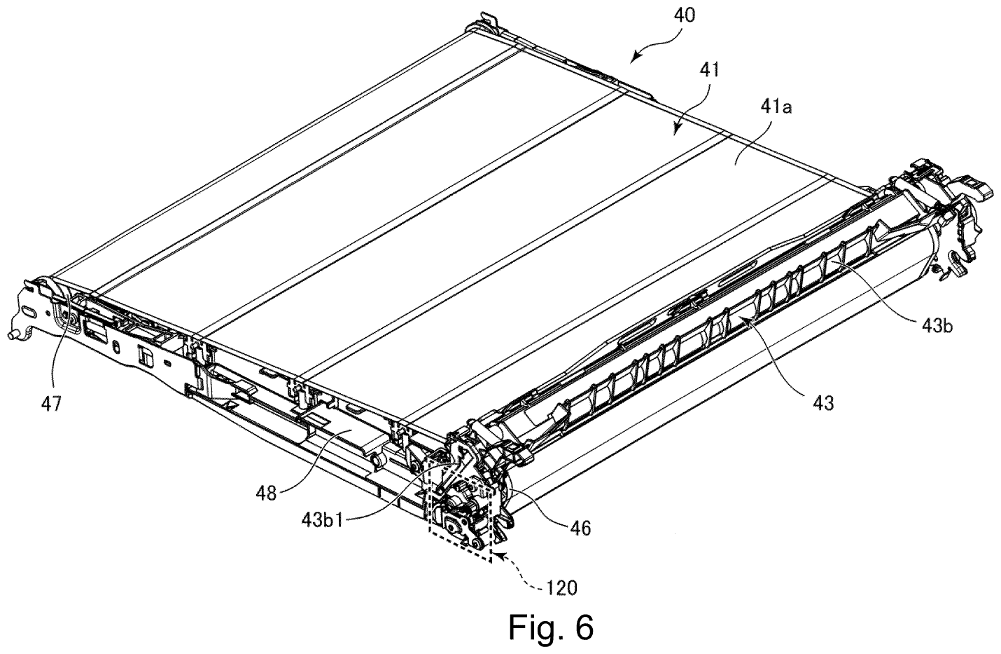

A waste toner conveying path will be described by using FIGS. 6 to 8. FIG. 6 is a perspective view showing a whole constitution of the transfer unit 40 in this embodiment. FIG. 7 is a perspective view of the transfer unit 40 for illustrating the waste toner conveying path in this embodiment, in which a state such that the belt 41, the cleaning container 43b of the cleaning portion 43, and the like are removed from the transfer unit 40 is shown.

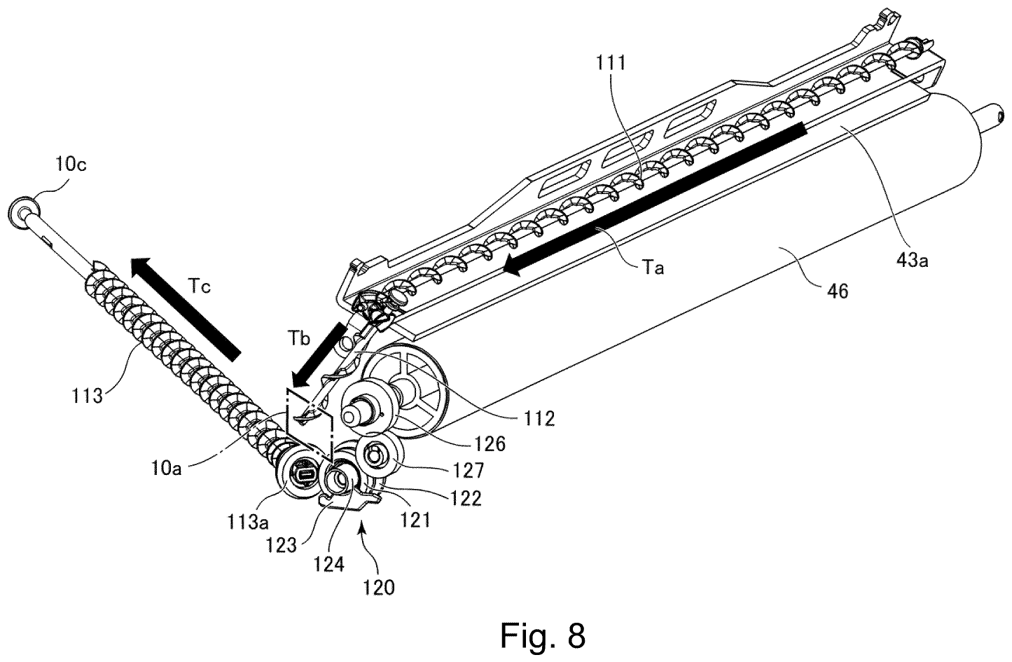

FIG. 8 is a perspective view showing the waste toner conveying path and drive connection mechanism in this embodiment.

The cleaning portion 43 includes the cleaning container 43b and the cleaning blade 43a provided inside the cleaning container 43b. The cleaning blade 43a extends along a widthwise direction (left-right direction) which is a direction substantially perpendicular to a surface movement direction of the belt 41. The cleaning blade 43a is disposed so as to contact the driving roller 46 through the belt 41. Further, the cleaning blade 43a is disposed so as to contact the surface (outer peripheral surface) of the belt 41 with respect to a counterdirection to the movement direction of the belt 41. That is, the cleaning blade 43a is contacted to the surface of the belt 41 in an attitude such that a free end portion thereof with respect to a widthwise (short) direction substantially perpendicular to a longitudinal direction disposed along the widthwise direction of the belt 41 is directed toward an upstream side of the surface movement direction of the belt 41. The cleaning blade 43a scrapes off the toner from the surface of the rotating belt 41 and accommodates the toner as the waste toner inside the cleaning container 43b. Here, the cleaning blade 43a is contacted to the belt 41 at a predetermined angle, so that the toner can be moved from the surface of the belt 41 by movement of the belt 41 in one direction. In this embodiment, a driving force is not inputted from the driving source to the driving roller 46 so that the belt 41 and the driving roller 46 are reversely rotated.

The transfer unit 40 includes a transfer frame 48 as frame for supporting the driving roller 46, the tension roller 47, the primary transfer rollers 42, and the like. In this embodiment, inside this transfer frame 48, a space (region) in which the waste toner is capable of being accommodated is provided. That is, in this embodiment, it can be said that the transfer frame 48 also functions as the waste toner collecting container 10. However, the waste toner collecting container 10 may also be constituted separately from the transfer frame 48 and may be mounted to the transfer frame 48. That is, in this embodiment, the waste toner collecting container 10 is provided in a region constituted by an inner peripheral surface of the belt 41. In this embodiment, in the apparatus main assembly 1a, the waste toner collecting container 10 is disposed so that a bottom thereof crosses a gravitational direction. Further, in this embodiment, the waste toner collecting container 10 is constituted in a substantially rectangular shape in the case where the waste toner collecting container 10 is viewed in a direction substantially perpendicular to the primary transfer surface 41a of the belt 41. In a portion of an upper surface of the waste toner collecting container 10 opposing the primary transfer rollers 42Y, 42M, 42C, and 42K, groove portions 10bY, 10bM, 10bC, and 10bK are formed, respectively, along a rotational axis direction (left-right direction) of each primary transfer roller 42. By this, the waste toner collecting container 10 does not restrict rotation of each primary transfer roller 42. The driving roller 46, the tension roller 47, and each primary transfer roller 42 are rotatably supported through a supporting portion provided to the transfer frame 48.

The cleaning portion 43 includes therein a cleaning screw 111 and an intermediary screw 112 which are as waste toner conveying members for conveying the waste toner removed from the belt 41 by the cleaning blade 43a. The cleaning screw 111 includes a rotation shaft disposed along the widthwise direction (left-right direction) of the belt 41 and a helical conveying portion formed along an axial direction of this rotation shaft. The cleaning screw 111 is drive-connected to the driving roller 46 by a drive connection portion (not shown), and is rotated by receiving the driving force inputted from the driving motor 5 to the driving roller 46. Further, the cleaning screw 111 conveys the waste toner in an arrow Ta direction (direction from a right side toward a left side) in FIG. 8 by being rotated. The intermediary screw 112 includes a rotation shaft disposed along a direction (direction crossing the horizontal direction) crossing a rotational axis direction of the cleaning screw 111 and a helical conveying portion formed along an axial direction of this rotation shaft. One end portion (upper side end portion) of the intermediary screw 112 with respect to the rotational axis direction is disposed close to one end portion (left side end portion) of the cleaning screw 111 with respect to the rotational axis direction. The intermediary screw 112 is drive-connected to the cleaning screw 111 in this one end portion and is rotated by receiving the driving force from the cleaning screw 111. Further, the intermediary screw 112 conveys the waste toner in an arrow Tb direction (direction from an upper side toward a lower side) in FIG. 8 by being rotated. The other end portion of the intermediary screw 112 with respect to the rotational axis direction is disposed close to one end portion (end portion on a left side and on a left side and on a front side) of a waste toner conveying screw 113 described later with respect to a rotational axis direction.

The intermediary screw 112 is provided inside a conveying path 43b1 (FIG. 6) provided in a left-side end portion of the cleaning container 43b. This conveying path 43b1 is connected to an inlet port 10a (FIG. 8) of the waste toner collecting container 10, and through this inlet port 10a, an inside of the waste toner collecting container 10 and an inside of the conveying path 43b1 communicate with each other. The waste toner conveyed in the arrow Ta direction in FIG. 8 by the cleaning screw 111 is conveyed in the arrow Tb direction in FIG. 8 by the intermediary screw 112, so that the waste toner flows into the waste toner collecting container 10 through the inlet port 10a.

Further, inside the waste toner collecting container 10, the waste toner conveying screw 113 as a waste toner conveying member is provided. The waste toner conveying screw 113 includes a rotation shaft and a helical conveying portion formed along an axial direction of this rotation shaft. One end portion (end portion on a left side and on a front side) of the waste toner conveying screw 113 with respect to a rotational axis direction is disposed close to the inlet port 10a of the waste toner collecting container 10. The other end portion of the waste toner conveying screw 113 with respect to the rotational axis direction is rotatably supported by a bearing portion 10c provided inside the waste toner collecting container 10. The waste toner conveying screw 113 is drive-connected to the driving roller 46 by a drive connection mechanism 120 described later, and is rotated through this drive connection mechanism 120 by receiving the driving force inputted from the driving motor 5 to the driving roller 46. Then, by the rotation, the waste toner conveying screw 113 conveys the waste toner, flowed into the waste toner collecting container 10 through the inlet port 10a, in an arrow Tc direction in FIG. 8.

In the case where the waste toner conveying screw 113 is viewed in a direction substantially perpendicular to the primary transfer surface 41a of the belt 41, the rotational axis direction of the waste toner conveying screw 113 is a direction which is not perpendicular to the movement direction (front-rear direction) of the primary transfer surface 41a and the widthwise direction (left-right direction) of the belt 41 and which crosses these directions. The waste toner flowed into the waste toner collecting container 10 through the inlet port 10a is conveyed by the waste toner conveying screw 113 toward a substantially central portion of the waste toner collecting container 10 in the case where the waste toner collecting container 10 is viewed in a direction substantially perpendicular to the primary transfer surface 41a of the belt 41 as shown by the arrow Tc in FIG. 8. An end portion of the helical conveying portion of the waste toner conveying screw 113 on a side opposite from the inlet port 10a with respect to the rotational axis direction of the waste toner conveying screw 113 is disposed in a substantially central portion of the waste toner collecting container 10. Accordingly, the waste toner conveyed by the waste toner conveying screw 113 is gradually charged while being diffused in a concentric circular shape from the substantially central portion of the waste toner collecting container 10.

Thus, the toner removed from the belt 41 by the cleaning blade 43a is conveyed toward the waste toner collecting container 10 by the cleaning screw 111 provided inside the cleaning container 43b and by the intermediary screw 112. Further, the waste toner collecting container 10 is provided with the waste toner conveying screw 113 for conveying the waste toner toward the substantially central portion of the waste toner collecting container 10, and the waste toner is accumulated inside the waste toner collecting container 10. The waste toner conveying screw 113 as a driven member is rotated by input of the driving force from the driving motor 5 as the driving source through the drive connection mechanism 120 described later. Further, when an amount of the waste toner is increased later. Further, when an amount of the waste toner is increased by an increase in number of sheets subjected to printing by the printer 1, the waste toner is conveyed radially from the central portion toward an outside of the waste toner collecting container 10.

In this embodiment, in the case where the amount of the waste toner accumulated in the waste toner collecting container 10 becomes a predetermined amount or more (typically, in the case where the waste toner amount exceeds the predetermined amount), a state thereof is detected and warning about the state is notified to the user. In this embodiment, this state is referred to as a “near full state”, and the warning notified to the user in the case where the waste toner amount became this state is referred to as “near full state notification”. In this embodiment, even after the near full state notification is made the printer 1 is capable of continuing the print operation until the amount of the waste toner collected in the waste toner collecting container 10 reaches a predetermined amount (second predetermined amount). Then, in the case where the amount of the waste toner collected in the waste toner collecting container 10 reached the predetermined amount (second predetermined amount) in which the waste toner is capable of being accumulated in the waste toner collecting container 10, a state thereof is detected, and warning about the state is notified to the user. In this embodiment, this state is referred to as a “full state”, and the warning notified to the user in the case where the waste toner amount became this state is referred to as “full state notification”. In this embodiment, when the full state notification is made, the operation of the printer 1 is stopped (the print operation is prohibited).

With an increasing amount of the waste toner in the waste toner collecting container 10, a density of the waste toner becomes higher. For that reason, a resisting force generated when the waste toner is conveyed by the waste toner conveying screw 113 becomes large, so that a rotational load torque of the waste toner conveying screw 113 increases.

In this embodiment, in the case where the rotational load torque of the waste toner conveying screw 113 becomes a predetermined value or more (overload state) (typically, in the case where the rotational load torque exceeds the predetermined value), the near full state of the waste toner collecting container 10 is detected by the detecting mechanism 100 (FIG. 13 and the like) described later. Then, on the basis of a detection result of this detecting mechanism 100, the controller 3 notifies the user of warning by display or the like in a screen of the operating portion 4 provided to the printer 1. This warning can be made by display of a message prompting preparation of exchange of the waste toner collecting container 10 or the like. Further, in place of or in addition to the operating portion 4, similar warning can be notified in a display portion or the like of the external host device 400 connected to the printer 1.

Further, in this embodiment, even after the near full state of the waste toner collecting container 10 is detected, the print operation can be continued until the amount of the waste toner collected in the waste toner collecting container 10 reached the predetermined amount and becomes the full state. In this embodiment, the controller calculates an amount of the toner, consumed by the print operation, on the basis of the image information from the near full state to the full state. That is, by counting the number of pixels of a print image, it is possible to calculate the amount of the toner consumed by the print operation. Then, in the case where the amount of the toner consumed by the print operation from detection of the near full state reached the predetermined amount, the controller 3 notifies the user of the warning by display or the like in the screen of the operating portion 4 provided to the printer 1. This warning can be made by display of a message or the like prompting exchange of the waste toner collecting container 10. However, a means for detecting the amount of the waste toner collected in the waste toner collecting container 10 after the near full state is detected is not limited to the above-described method. For example, methods in which the number of sheets subjected to the printing is counted, in which a detecting means for detecting the full state is provided, and in which a rotation time or a number of rotations of the driving roller 46 (transfer unit 40) is counted may be used. Further, in place of or in addition to the operating portion 4, in the display portion or the like of the external host device 400 connected to the printer, similar warning can be notified.

### <Drive Connecting Mechanism>

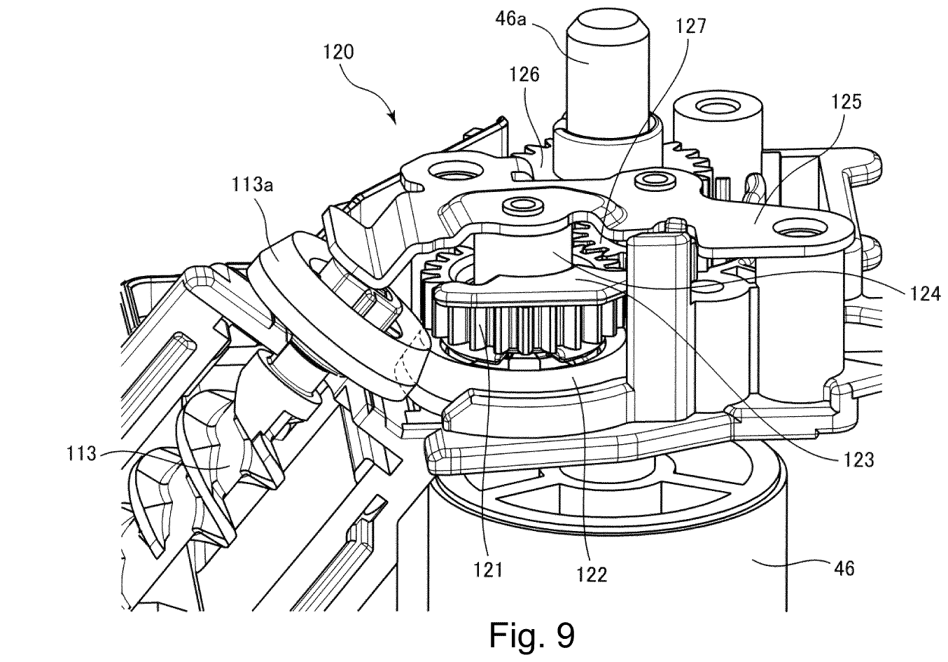

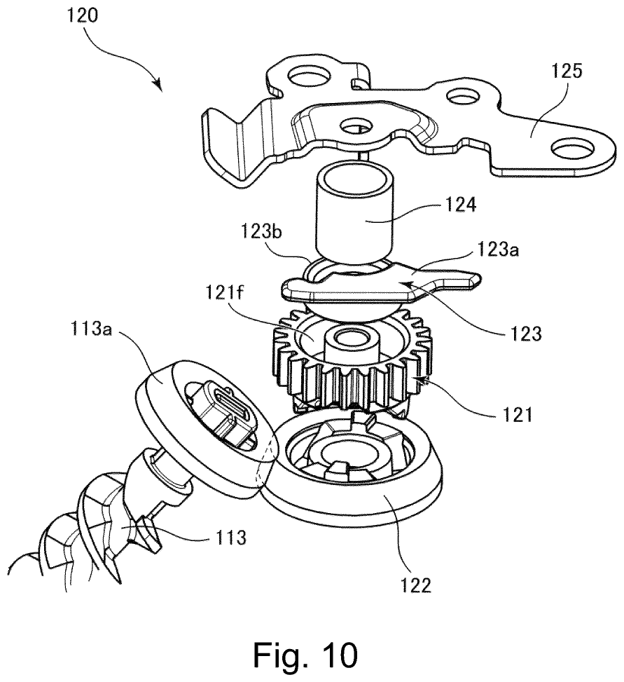

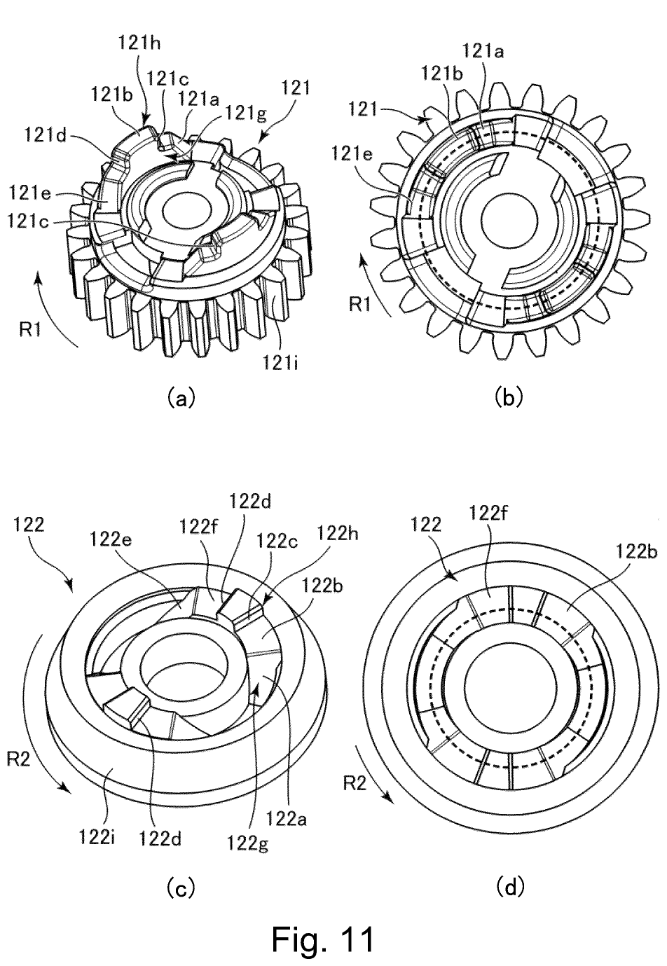

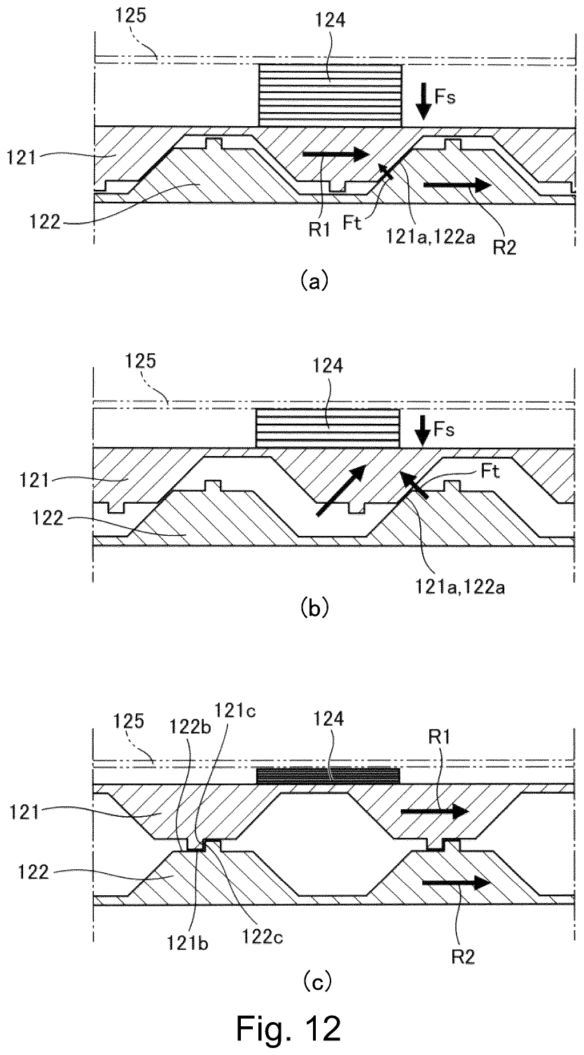

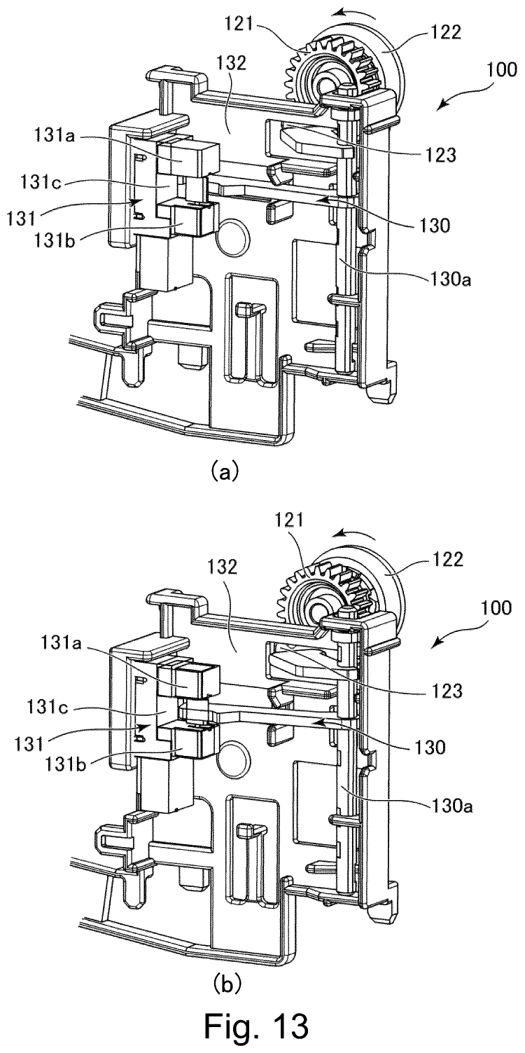

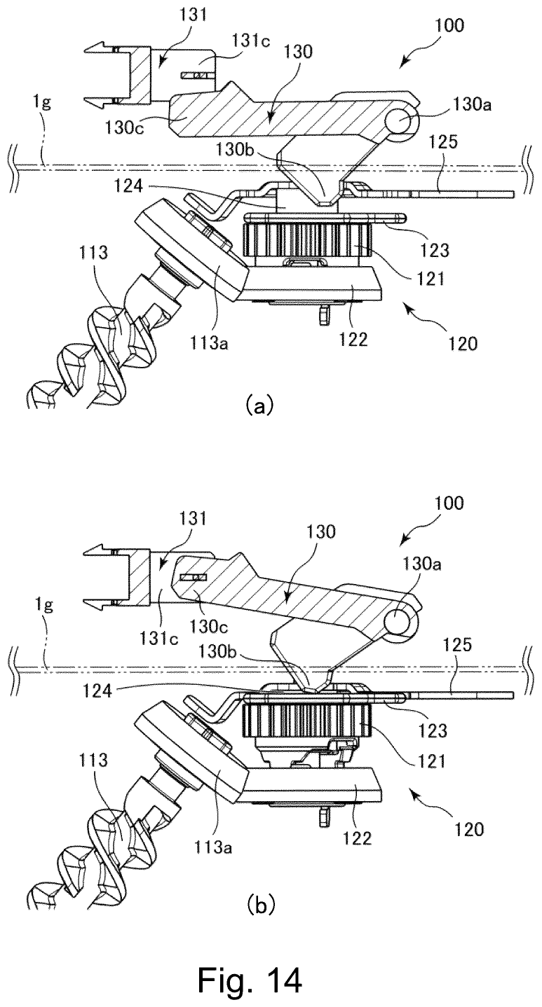

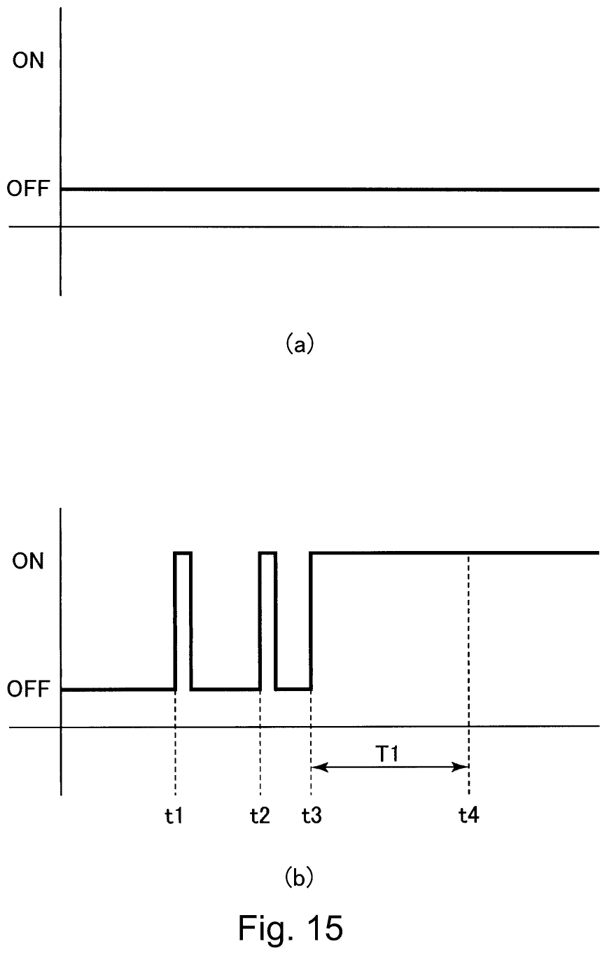

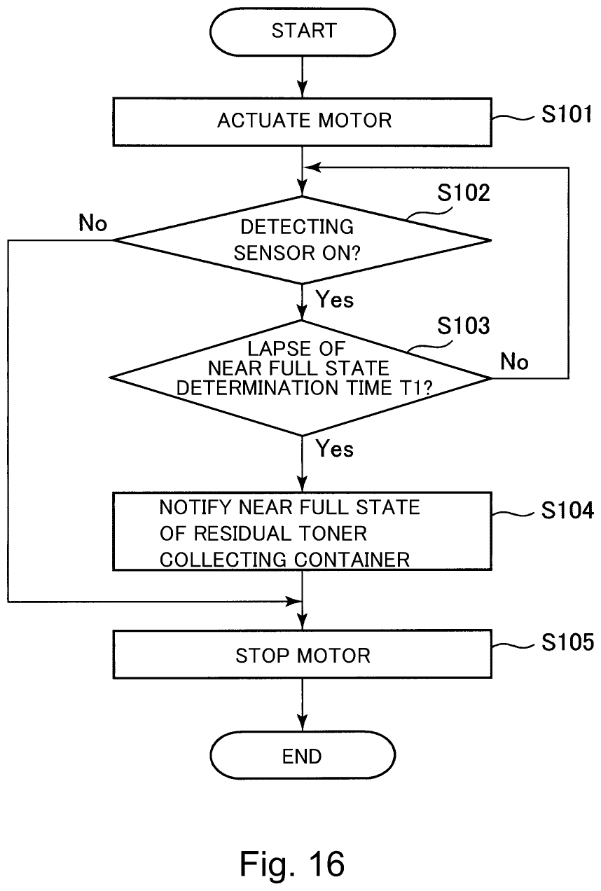

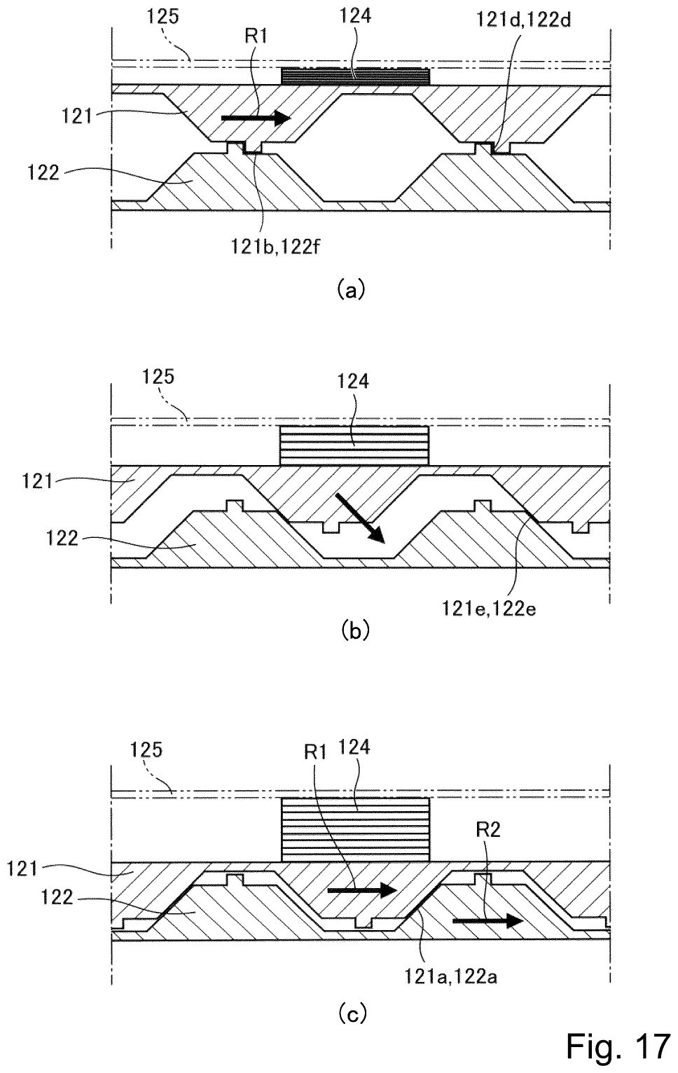

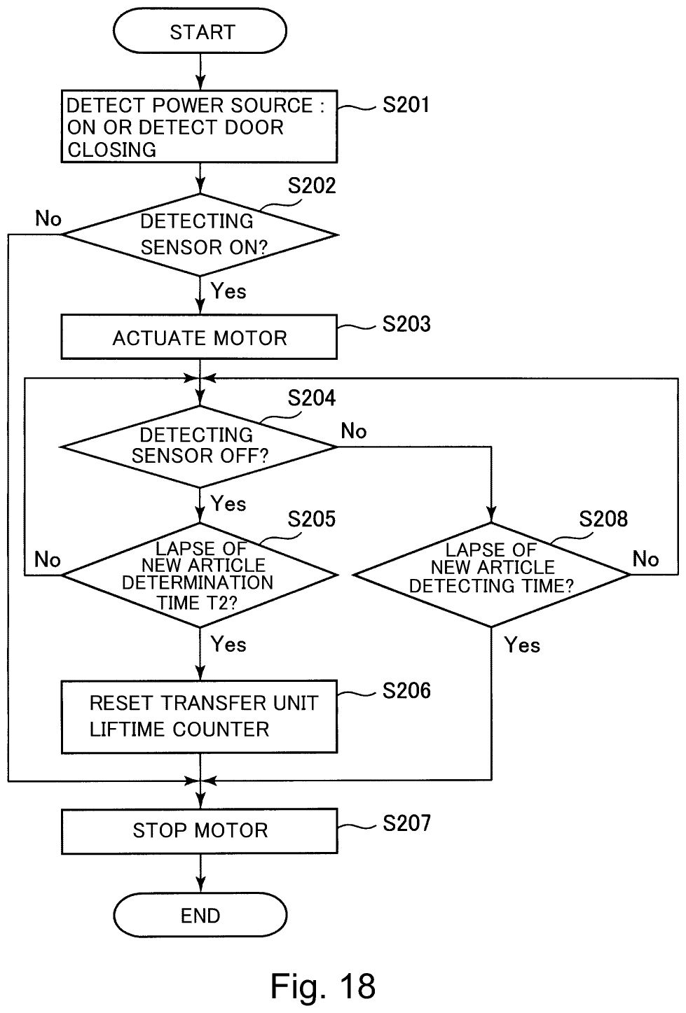

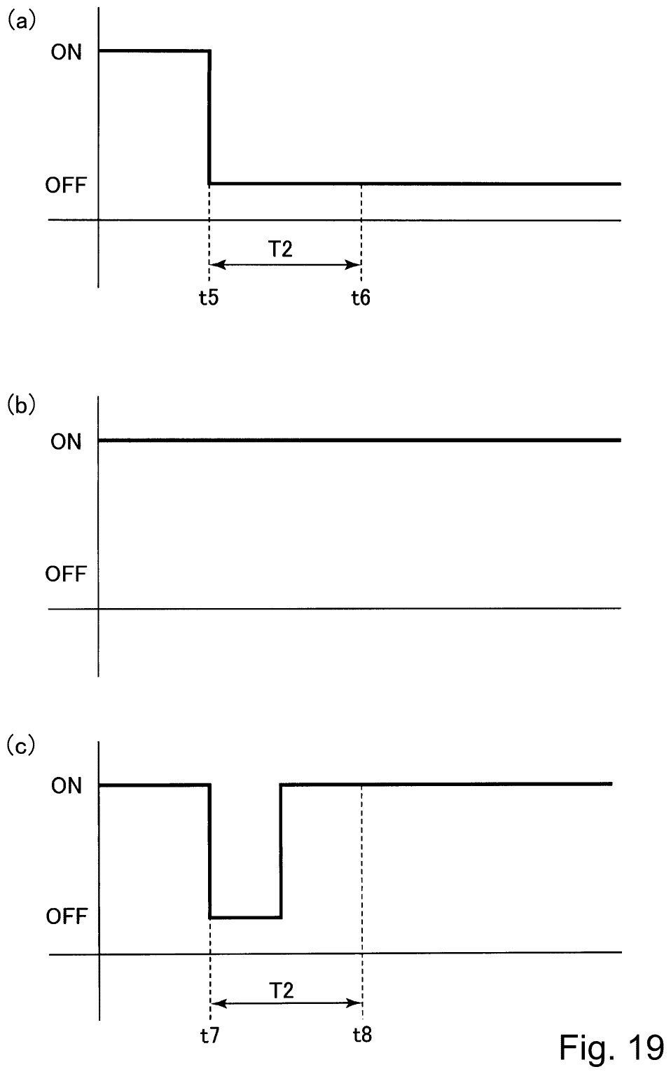

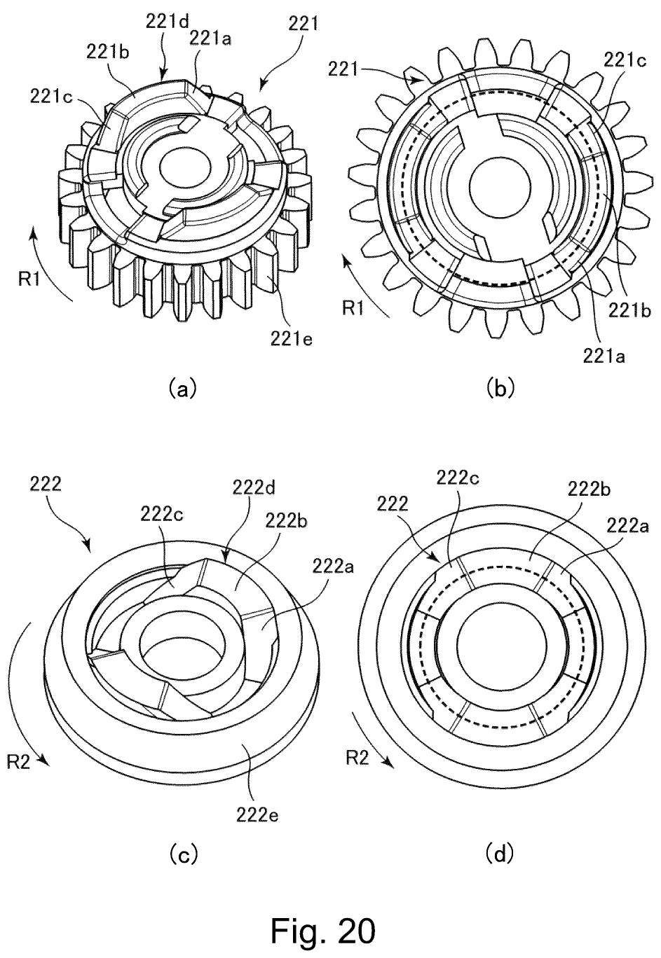

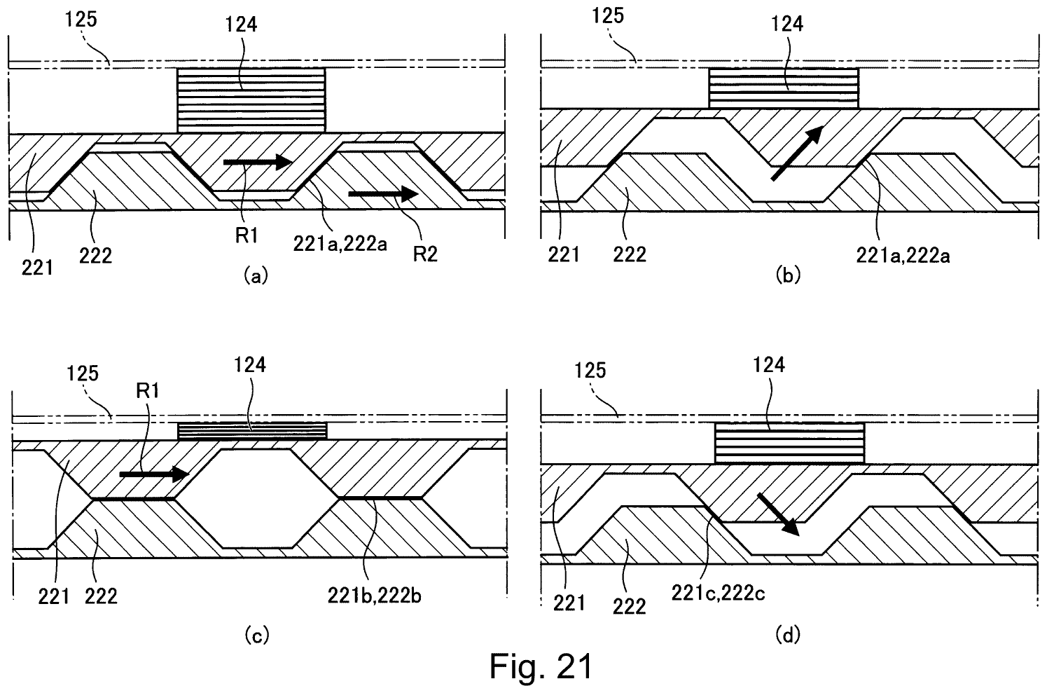

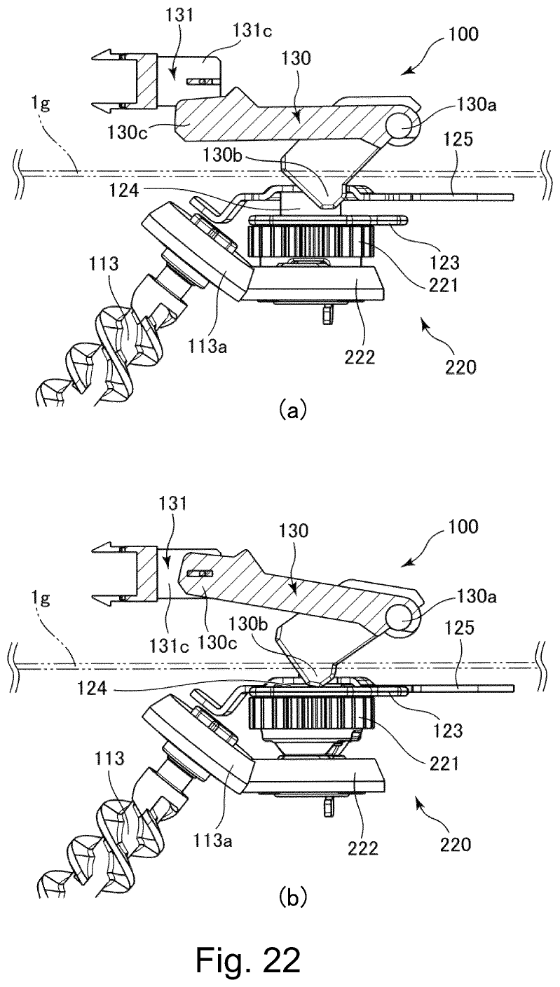

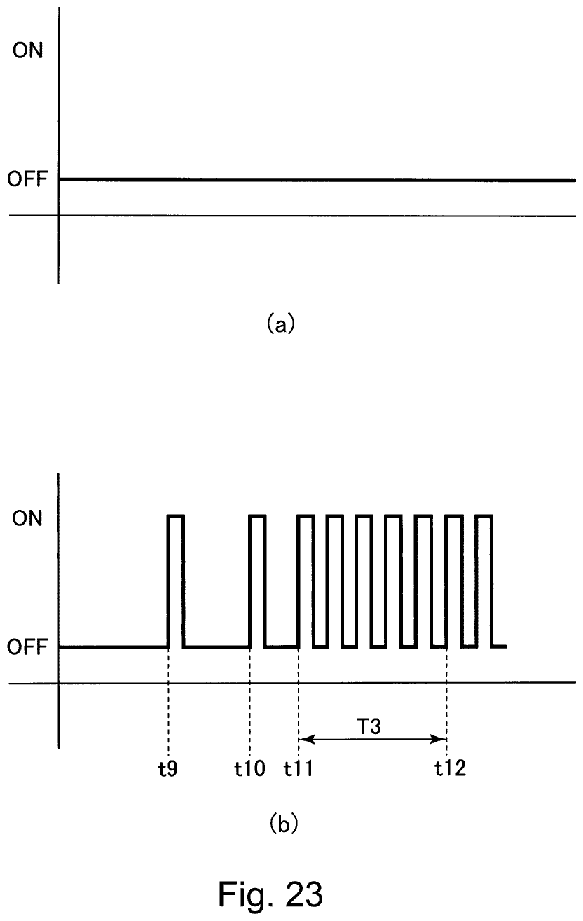

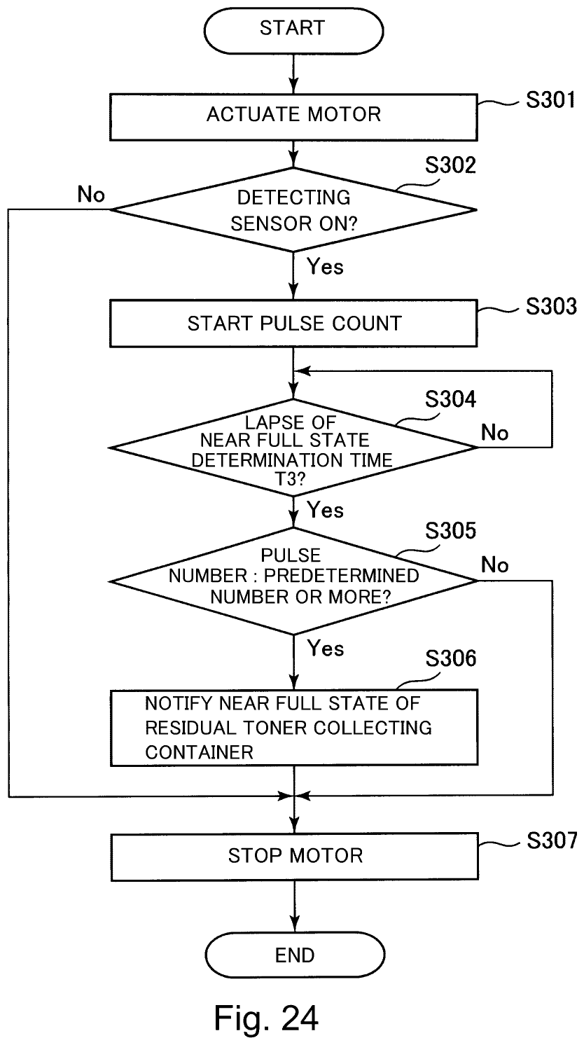

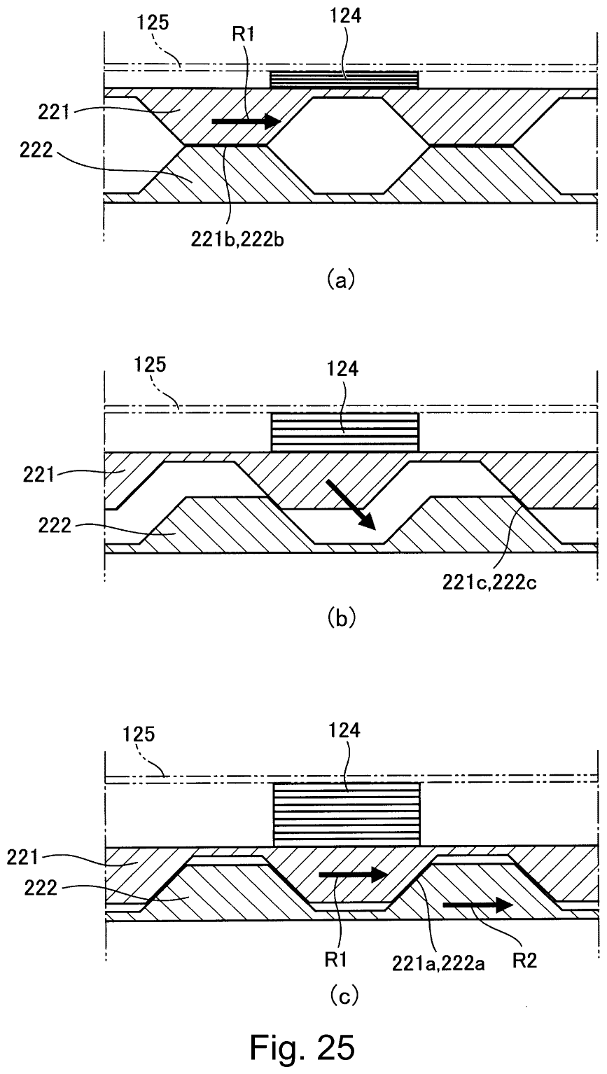

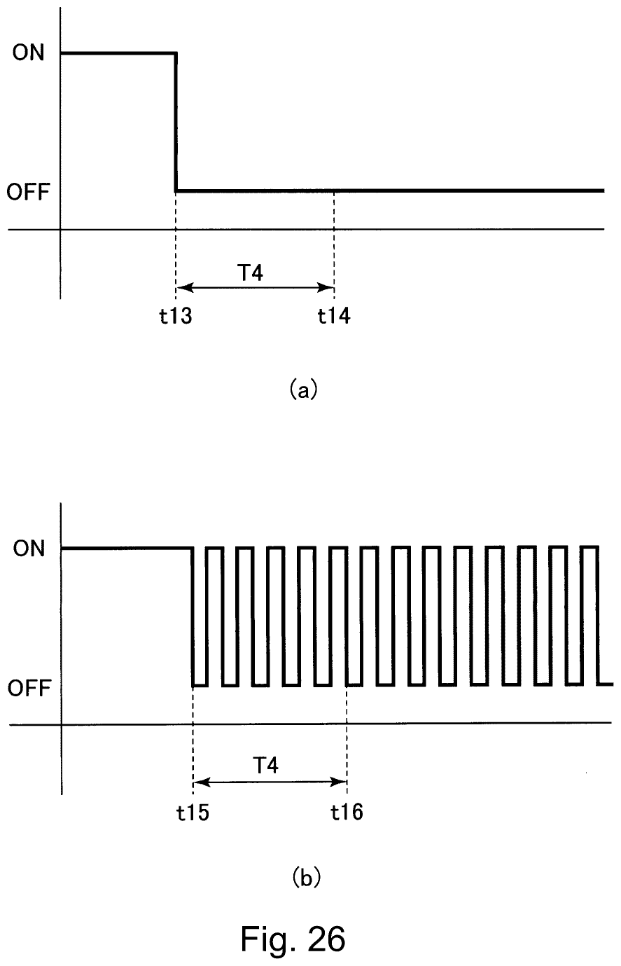

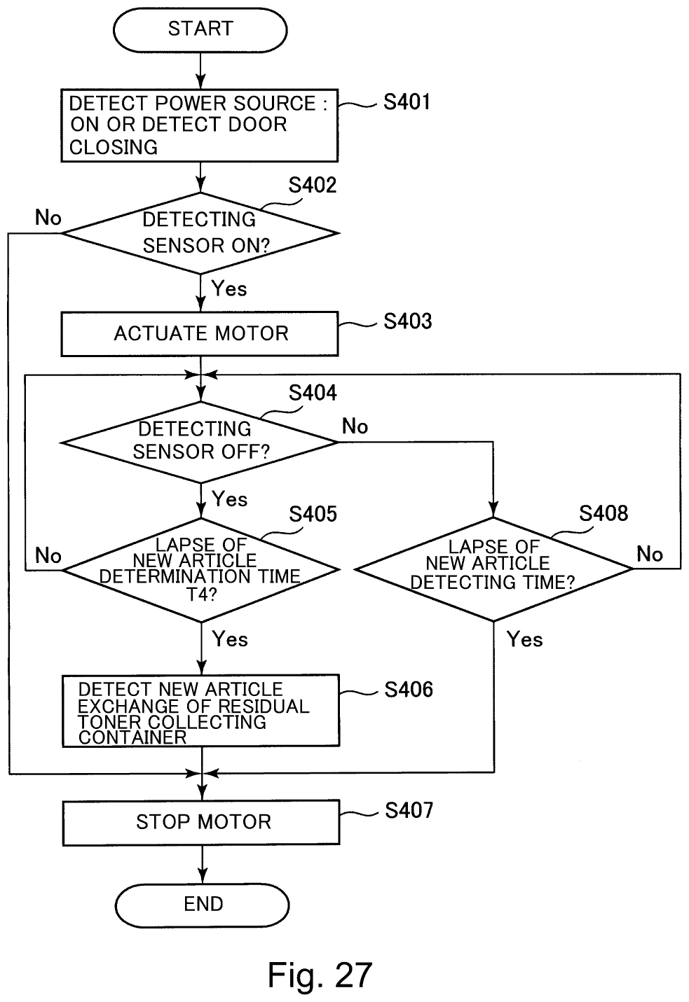

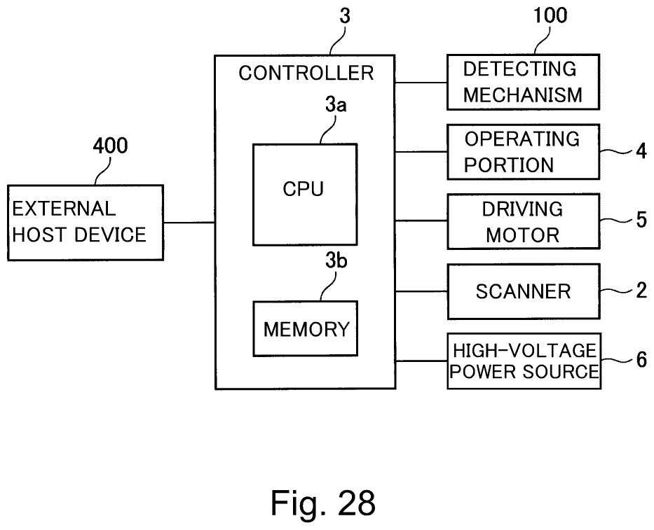

By using FIGS. 8 to 10, the drive connection mechanism 120 as a drive connection means (drive connection portion) for transmitting the driving force from the driving motor 5 to the waste toner conveying screw 113 in this embodiment will be described. FIG. 9 is a perspective view of the drive connection mechanism 120 in this embodiment. FIG. 10 is an exploded perspective view of the drive connection mechanism 120 in this embodiment.

As shown in FIG. 8, the waste toner conveying screw 113 and the driving roller 46 are drive-connected to each other by the drive connection mechanism 120 provided to the transfer unit 40. The drive connection mechanism 120 is provided in an end portion of the driving roller 46 on a left side with respect to the rotational axis direction of the driving roller 46. As shown in FIGS. 9 and 10, the drive connection mechanism 120 is constituted by including a movable gear 121, a fixed gear 122, a detecting lever 123, an urging spring 124, a cover member 125, a driving gear 126, and an idler gear 127.

The movable gear 121 is a drive transmitting member for receiving the driving force from a driving roller 46 side and is provided movably along a rotation axis direction thereof. The movable gear 121 is movable to a first position and a second position which are changed in relative position to the fixed gear 122 with respect to the rotation axis direction in interrelation with a change in relative position of the fixed gear 122 to the movable gear 121 with respect to a rotational direction depending on a magnitude of the rotational load torque of the waste toner conveying screw 113 as described later. The fixed gear 122 is a drive transmitting member for receiving the driving force from the movable gear 121 by being engaged with the movable gear 121 and for transmitting the driving force to the waste toner conveying screw 113 by being engaged with a waste toner conveying screw gear 113a provided to the waste toner conveying screw 113. The waste toner conveying screw gear 113a is provided to the rotation shaft of the waste toner conveying screw 113 so as to be rotated integrally with the waste toner conveying screw 113 in one end portion (end portion on the left side and on the front side) of the waste toner conveying screw 113 with respect to the rotational axis direction. The detecting lever 123 is a detecting member for detecting movement of the movable gear 121 by being moved integrally with the movable gear 121. The detecting lever 123 includes a lever portion 123a and a lever supporting portion 123b, and the lever supporting portion 123b is engaged in a movable gear recessed portion 121f provided in the movable gear 121. By this, the detecting lever 123 is held by the movable gear 121 rotatably relative to the movable gear 121 so that a position of the lever portion 123a with respect to the rotation direction of the movable gear 121 is maintained. The urging spring 124 is an urging member (a compression coil spring which is an elastic member in this embodiment) as an urging means for urging the movable gear 121 through the detecting lever 123 toward the fixed gear 122 along the rotational axis direction of the movable gear 121. The cover member 125 is a holding member having a function of holding the drive connection mechanism 120 to the transfer frame 48, and is fixed to the transfer frame 48. The driving gear 126 is provided to a rotation shaft 46a of the driving roller 46 so as to be rotated integrally with the driving roller 46 in one end portion (end portion on the left side) of the driving roller 46 with respect to the rotational axis direction. The idler gear 127 receives the driving force from the driving gear 126 by being engaged with the driving gear 126, and transmits the driving force to the movable gear 121. That is, the driving gear 126 transmits the drive to the movable gear 121 through the idler gear 127. From the driving motor 5 toward the driving roller 46, for example, the driving force is inputted through a drive connection portion (not shown) provided in the other end portion (end portion on the right side) with respect to the rotational axis direction of the driving roller 46.

Here, a surface of the fixed gear 122 on a side opposite from the movable gear 121 with respect to the rotational axis direction abuts against a wall surface of the transfer frame 48. The urging spring 124 is disposed between the cover member 125 of which position is fixed and the detecting lever 123 movable together with the movable gear 121 along the rotational axis direction of the movable gear 121. Further, the movable gear 121 and the detecting lever 123 are urged by the urging spring 124 toward the fixed gear 122 along the rotational axis direction of the movable gear 121. That is, the movable gear 121 and the detecting lever 123 are disposed between the fixed gear 122 and the cover member 125 with a degree of freedom such that the movable gear 121 and the detecting lever 123 are movable along the rotational axis direction of the movable gear 121.

Thus, the drive connection mechanism 120 includes the movable gear 121 as a first rotatable member (first member, rotatable member) disposed on an input side of the rotational driving force, the fixed gear 122 as a second rotatable member (second member, member-to-be-rotated) provided coaxially with and rotatably relative to the first rotatable member and disposed on an output side of the rotational driving force, the urging spring 124 as the urging member (elastic member) for applying an urging force (elastic force) in a direction in which the movable gear 121 is urged against the fixed gear 122 along the rotational axis direction, and the detecting lever 123 movable together with the movable gear 121.

Parts (a) and (b), and (c) and (d) of FIG. 11 are perspective views and front views, respectively, specifically showing the movable gear 121 and the fixed gear 122, respectively, in this embodiment. Part (a) of FIG. 11 is the perspective view showing a surface of the movable gear 121 on the fixed gear 122 side in the rotational axis direction of the movable gear 121, and part (b) of FIG. 11 is the front view showing the surface of the movable gear 121. Part (c) of FIG. 11 is the perspective view showing a surface of the fixed gear 122 on the movable gear 121 side in the rotational axis direction of the fixed gear 122, and part (d) of FIG. 11 is the front view showing the surface of the fixed gear 122.

The movable gear 121 and the fixed gear 122 include cam shapes (cam-shaped portions) engageable with each other.

The movable gear 121 rotates in an arrow R1 direction in parts (a) and (b) of FIG. 11. The movable gear 121 includes the cam shape along the rotational direction (circumferential direction). The movable gear 121 includes a first inclined surface portion 121a, a flat surface portion 121b, a first vertical wall portion 121c, a second vertical wall portion 121d, and a second inclined surface portion 121e. Of the first inclined surface portion 121a and the second inclined surface portion 121e, the first inclined surface portion 121a is provided on a downstream side of the movable gear 121 with respect to the rotational direction, and the second inclined surface portion 121e is provided on an upstream side of the movable gear 121 with respect to the rotational direction. The first inclined surface portion 121a is inclined with respect to the rotational axis direction of the movable gear 121 so as to approach the fixed gear 122 toward the upstream side of the movable gear 121 with respect to the rotational direction. Further, the second inclined surface portion 121e is inclined with respect to the rotational axis direction of the movable gear 121 so as to be separated from the fixed gear 122 toward the upstream side of the movable gear 121 with respect to the rotational direction. Further, on a surface of a base portion 121g, on the fixed gear 122 side, where the first inclined surface portion 121a and the second inclined surface portion 121e, a projected shape portion including the first vertical wall portion 121c, the second vertical wall portion 121d, and the flat surface portion 121b is provided. Each of the first vertical wall portion 121c and the second vertical wall portion 121d extends along (in this embodiment, substantially parallel to) the rotational axis direction of the movable gear 121. Of the first vertical wall portion 121c and the second vertical wall portion 121d, the first vertical wall portion 121c is provided on the downstream side of the movable gear 121 with respect to the rotational direction, and the second vertical wall portion 121d is provided on the upstream side of the movable gear 121 with respect to the rotational direction. The flat surface portion 121b extends between the first vertical wall portion 121c and the second vertical wall portion 121d along a surface of the movable gear 121 crossing (in this embodiment, substantially perpendicular to) the rotational axis direction of the movable gear 121. Further, the movable gear 121 includes a gear portion 121i at an outer periphery thereof.

The fixed gear 122 rotates in an arrow R2 direction in parts (c) and (d) of FIG. 11. The fixed gear 122 includes the cam shape along the rotational direction (circumferential direction) on a surface thereof on the movable gear 121 side with respect to the rotational axis direction. The fixed gear 122 includes a first fixing inclined surface portion 122a, a first fixing flat surface portion 122b, a first fixing vertical wall portion 122c, a second fixing vertical wall portion 122d, a second fixing inclined surface portion 122e, and a second fixing flat surface portion 122f. Of the first fixing inclined surface portion 122a and the second fixing inclined surface portion 122e, the first fixing inclined surface portion 122a is provided on an upstream side of the fixed gear 122 with respect to the rotational direction, and the second fixing inclined surface portion 122e is provided on a downstream side of the fixed gear 122 with respect to the rotational direction. The first fixing inclined surface portion 122a is inclined with respect to the rotational axis direction of the fixed gear 122 so as to be separated from the movable gear 121 toward the upstream side of the fixed gear 122 with respect to the rotational direction. Further, the second fixing inclined surface portion 122e is inclined with respect to the rotational axis direction of the fixed gear 122 so as to approach the movable gear 121 toward the upstream side of the fixed gear 122 with respect to the rotational direction. Further, on a surface of a fixing base portion 122g, on the movable gear 121 side, where the first fixing inclined surface portion 122a and the second fixing inclined surface portion 122e are formed, a fixing projected shape portion 122h including the first fixing vertical wall portion 122c and the second fixing vertical wall portion 122d is provided. Each of the first fixing vertical wall portion 122c and the second fixing vertical wall portion 122d extends along (in this embodiment, substantially parallel to) the rotational axis direction of the fixed gear 122. Of the first fixing vertical wall portion 122c and the second fixing vertical wall portion 122d, the first fixing vertical wall portion 122c is provided on the upstream side of the fixed gear 122 with respect to the rotational direction, and the second fixing vertical wall portion 122d is provided on the downstream side of the fixed gear 122 with respect to the rotational direction. Each of the first fixing flat surface portion 122b and the second fixing flat surface portion 122f extends along a surface of the fixed gear 122 crossing (in this embodiment substantially perpendicular to) the rotational axis direction of the fixed gear 122. Of the first fixing flat surface portion 122b and the second fixing flat surface portion 122f, the first fixing flat surface portion 122b is provided on the upstream side of the fixed gear 122 with respect to the rotational direction, and the second fixing flat surface portion 122f is provided on the downstream side of the fixed gear 122 with respect to the rotational direction. The first fixing flat surface portion 122b and the second fixing flat surface portion 122f are provided on the upstream side and the downstream side, respectively, with respect to the rotational direction of the fixed gear 122, while sandwiching the fixing projected shape portion 122h therebetween. Further, the fixed gear 122 includes a gear portion 122i at an outer periphery thereof.

Incidentally, in this embodiment, the movable gear 121 is provided with a cam shape (portion) which is the same as the above-described cam shape also on an opposite side (in a position shifted by 180 degrees with respect to the rotation direction) with respect to the rotational axis direction of the movable gear 121. Similarly, the fixed gear 122 is provided with a cam shape (portion) which is the same as the above-described can shape also on an opposite side (in a position shifted by 180 degrees with respect to the rotational direction) with respect to the rotational axis direction of the fixed gear 122.

Parts (a), (b), and (c) of FIG. 12 are sectional views in which the cam shapes of the movable gear 121 and the fixed gear 122 are cut at broken line portions in parts (b) and (d) of FIG. 11, and each schematically shows an operation of the drive connection mechanism 120 during a rotational operation of the driving roller 46. Each of parts (a), (b), and (c) of FIG. 12 shows a state of the movable gear 121 and the fixed gear 122 in the case where an amount of the waste toner in the waste toner collecting container 10 (a rotational load torque of the waste toner conveying screw 113) is different as described later.

The movable gear 121 is urged by the urging spring 124 with a spring force (spring pressure) Fs toward the fixed gear 122 along the rotational axis direction of the movable gear 121. When the movable gear 121 is rotated in the arrow R direction by receiving drive input, the first inclined surface portion 121a and the first fixing inclined surface portion 122a are in contact with each other, so that the movable gear 121 receives a reaction force Ft depending on a rotational load torque of the fixed gear 122. Part (a) of FIG. 12 shows a state in which the amount of the waste toner in the waste toner collecting container 10 is less than a predetermined amount (herein, this state also referred to as a “normal state”). In this state, the amount of the waste toner in the waste toner collecting container 10 is less than the predetermined amount, and therefore, the rotational load torque of the fixed gear 122 receiving a conveyance resistance of the waste toner is smaller than a predetermined value. That is, the reaction force Ft exerted on the movable gear 121 is smaller than the spring force Fs, and therefore, the first inclined surface portion 121a and the first fixing inclined surface portion 122a contact (engage with) each other, so that the driving force is transmitted from the movable gear 121 to the fixed gear 122. Further, the fixed gear 122 is rotated in the arrow R2 direction.

When the amount of the waste toner in the waste toner collecting container 10 reaches the predetermined amount (near full state in this embodiment), the rotational load torque of the fixed gear 122 increases, so that the reaction force Ft exerted on the movable gear 121 balances with the spring force Fs. Then, with an increase in amount of the waste toner in the waste toner collecting container 10, as shown in part (b) of FIG. 12, the first inclined surface portion 121a and the first fixing inclined surface portion 122a relative slide with each other. By this, the movable gear 121 moves in a direction (direction in which the movable gear 121 is separated from the fixed gear 122 along the rotational axis direction of the movable gear 121) opposite to the urging direction of the urging spring 124.

Thereafter, as shown in part (c) of FIG. 12, the first inclined surface portion 121a and the first fixing inclined surface portion 122a are in separated state. Further, as shown in part (c) of FIG. 12, a state in which the flat surface portion 121b and the first fixing flat surface portion 122b contact (engage with) each other and in which the first vertical wall portion 121c and the first fixing vertical wall portion 122c contact (engage with) each other is formed. Thus, when the amount of the waste toner in the waste toner collecting container 10 becomes the predetermined amount or more, the first vertical wall portion 121c and the first fixing vertical wall portion 122c contact each other, so that the driving force is transmitted from the movable gear 121 to the fixed gear 122. That is, as long as the movable gear 121 is rotated in the arrow R1 direction, the movable gear 121 does not return to the state of part (a) of FIG. 12.

Incidentally, in this embodiment, both the first inclined surface portion 121a and the first fixing inclined surface portion 122a are made the surfaces inclined with respect to the rotational axis direction of the movable gear 121, but at least one of these portions may only be required to be made such an inclined surface. For example, one portion is made the surface inclined with respect to the rotational axis direction of the movable gear 121, and the other portion may be made a rib shape (portion) or a boss shape (portion) which contacts the inclined surface. Further, in this embodiment, both the first vertical wall portion 121c and the first fixing vertical wall portion 122c which contact each other are made surfaces substantially parallel to the rotational axis direction of the movable gear 121, but at least one of these portions may only be required to be made such a surface. For example, one portion is made the surface substantially parallel to the rotational axis direction of the movable gear 121, and the other portion may be made a rib shape or a boss shape which contacts the surface. Further, in this embodiment, the flat surface portion 121b as the restricting portion provided on the movable gear 121 restricted the change in phase of the fixed gear 122 in contact with the first fixing flat surface portion 122b of the fixed gear 122. However, as is understood from part (c) of FIG. 12, the restricting portion (flat surface portion of a top portion of the fixing projected shape portion 122h) provided to the fixed gear 122 contacts the movable gear 121, so that the restricting portion may restrict the change in phase of the fixed gear 122. That is, the restricting portion may only be required to be provided to at least one of the movable gear 121 and the fixed gear 122.

### <Near Full State Detecting Method>

By using parts (a) and (b) of FIG. 13 and parts (a) and (b) of FIG. 14, the detecting mechanism 100 as a detecting means (detecting portion) capable of detecting the movement of the movable gear 121 in the rotational axis direction will be described. Parts (a) and (b) of FIG. 13 are perspective views each showing the detecting mechanism 100 in this embodiment. Further, parts (a) and (b) of FIG. 14 are sectional views each showing the detecting mechanism 100 in this embodiment. The detecting mechanism 100 is capable of detecting the movement of the movable gear 121 in the rotational axis direction, whereby the detecting mechanism 100 is capable of detecting that the rotational load torque of the waste toner conveying screw 113 become the predetermined value or more (overload state).

As shown in parts (a) and (b) of FIG. 13 and parts (a) and (b) of FIG. 14, a detecting flag 130 and a detecting sensor 131 are mounted to and held by a sensor holder 132 provided to a main assembly side plate 1g which is a side plate provided to the apparatus main assembly 1a. The detecting flag 130 includes a flag rotation shaft 130a, a movement receiving portion 130b contactable to a lever portion 123a of a detecting lever 123 provided to the drive connection mechanism 120, and a light blocking portion 130c capable of entering into and retracting from a detecting region 131c of the detecting sensor 131. The detecting flag 130 is mounted to a sensor holder 132 so as to be rotatable about the flag rotation shaft 130a by that the flag rotation shaft 130a is rotatably supported by the sensor holder 132. further, an attitude of the detecting flag 130 is held so that the movement receiving portion 130b is moved toward the detecting lever 123 side by a spring and a stopper which are not shown and so that the light blocking portion 130c is in a position retracted from the detecting region 131c of the detecting sensor 131 (at least an optical axis of detection light). That is, the attitude of the detecting flag 130 is held in a state of part (a) of FIG. 14. In this embodiment, the detecting sensor 131 constituting the detecting means is constituted by a light blocking/light transmission detecting sensor (photosensor). The detecting sensor 131 is constituted in a U-shape in cross section and includes a light projecting portion 131a, a light receiving portion 131b, and the detecting region 131c formed between the light projecting portion 131a and the light receiving portion 131b. The detecting region 131c constitutes an optical path of detection light from the light projecting portion 131a toward the light receiving portion 131b and permits positioning of the light blocking portion 130c of the detection flag 130 therein. In this embodiment, the detecting mechanism 100 is constituted by including the detecting flag 130 and the detecting sensor 131. In this embodiment, the detecting mechanism 100 is capable of detecting that the position of the movable gear 121 with respect to the rotational direction is the first position (state in which the rotational load torque is less than the predetermined value) and is the second position (state in which the rotational load torque is the predetermined value or more) by detecting states of light blocking and light transmission by the detecting sensor 131.

Part (a) of FIG. 13 and part (a) of FIG. 14 show the state in which the amount of the waste toner in the waste toner collecting container 10 is less than the predetermined amount. That is, part (a) of FIG. 13 and part (a) of FIG. 14 show the normal state in which the movable gear 121 and the fixed gear 122 engage with each other by the first inclined surface portion 121a and the first fixing inclined surface portion 122a. Part (b) of FIG. 13 and part (b) of FIG. 14 show a state in which the amount of the waste toner in the waste toner collecting container 10 reached the predetermined amount, i.e., the near full state. That is, part (b) of FIG. 13 and part (b) of FIG. 14 show a state in which the movable gear 121 and the fixed gear 122 contact each other by the flat surface portion 121b and the first fixing flat surface portion 122b and by the first vertical wall portion 121c and the first fixing vertical wall portion 122c.

In this embodiment, when the detecting lever 123 contacts the detecting flag 130 with the movement of the movable gear 121 in the rotational axis direction, the detecting flag 130 is rotated about the rotation shaft 130a, so that the detecting sensor 131 is caused to detect blocking or transmission of light. Further, in the state, shown in part (a) of FIG. 13 and part (a) of FIG. 14, in which the amount of the waste toner in the waste toner collecting container 10 is less than the predetermined amount, the detecting lever 123 is separated from the movement receiving portion 130b of the detecting flag 130. Further, the light blocking portion 130c of the detecting flag 130 retracts from the detecting region 131c of the detecting sensor 131. As shown in part (b) of FIG. 13 and part (b) of FIG. 14, when the amount of the waste toner in the waste toner collecting container 10 reaches the predetermined amount, by the above-described operation, the movable gear 121 and the detecting lever 123 are moved along the rotational axis direction of the movable gear 121. When the lever portion 123a of the detecting lever 123 contacts the movement receiving portion 130b of the detecting flag 130 with this movement, the detecting flag 130 is rotated about the flag rotation shaft 130a. By this, the light blocking portion 130c of the detecting flag 130 enters the detecting region 131c of the detecting sensor 131 and blocks the optical axis of the detection light of the detecting sensor 131. Thus, the detecting sensor 131 detects the light blocking state, whereby the detecting mechanism 100 can detect that the inside of the waste toner collecting container 10 is in the near full state. That is, the state of the detecting sensor 131 is capable of shifting to the light transmission state as a first state and the light blocking state as a second state. The detecting flag 130 shifts the state of the detecting sensor 131 to the light blocking state or the light transmission state. The detecting flag 130 puts the state of the detecting sensor 131 in the light blocking state by blocking the optical path of the detecting sensor 131, and puts the state of the detecting sensor 131 in the light transmission state by opening the optical path of the detecting sensor 131. The detecting sensor 131 outputs different detection signals depending on the light blocking state and the light transmission state, respectively. In this embodiment, an output signal (detection signal) of the detecting sensor is turned off (OFF) in the light transmission state and is turned on (ON) in the light blocking state. This detection signal is inputted to the controller 3. By this, the controller 3 is capable of discriminating (detecting) that the state of the inside of the waste toner collecting container 10 is the near full state.

Parts (a) and (b) of FIG. 15 each shows an example of a detection pattern of the detection signal outputted from the detecting sensor 131 when the detecting mechanism 100 detects the near full state (near full state detection). During rotation of the driving roller 46, in a normal state, the detecting sensor 131 outputs an OFF signal. Part (a) of FIG. 15 shows the detection pattern in this case. When the amount of the waste toner in the waste toner collecting container 10 becomes the vicinity of the predetermined amount, by an operation shown in part (b) of FIG. 12, the detecting sensor 131 outputs an ON signal. However, a state of the waste toner in the waste toner collecting container 10 is not necessarily stabilized, and therefore, when the conveyance resistance of the waste toner conveying screw 113 lowers due to the factor such as the vibration, the state of the movable gear 121 returns again to the state of part (a) of FIG. 12 in some instances. Part (b) of FIG. 15 shows the detection pattern in this case.

FIG. 16 is a flowchart of the near full state detection in this embodiment. The controller 3 carries out control so as to actuate the driving motor 5, for example, with a start of the image forming operation (S101).

When the controller 3 detects the ON signal of the detecting sensor 131 (S102: Yes), a count of a near full state determination time T1 is started, and during the near full state determination time T1, the controller 3 discriminates whether or not the ON signal is continuously detected (S102, S103). That is, the controller 3 discriminates whether or not the near full state determination time T1 has elapsed in a state in which the ON signal is detected. The near full state determination signal is set in advance as a time in which the ON signal such that the waste toner collecting container 10 can be discriminated as being in the near full state with sufficient accuracy is continued. Further, in the case where the ON signal is continuously detected during the near full state determination time T1 (S103: Yes), the controller 3 detects the near full state, and performs near full state notification (S104). Then, the controller 3 carries out control so as to stop drive of the motor 5, for example, with an end of the image forming operation (S105). On the other hand, in the case where the OFF signal is detected before the near full state determination time T1 has elapsed and in the case where the ON signal of the detecting sensor 131 is not detected (S102: No), the controller 3 causes the processing to go to S105.

At timings t1 and t2 shown in part (a) of FIG. 15, the detecting sensor 131 outputs the ON signal, but the OFF signal is outputted earlier than a lapse of the near full state determination time T1, and therefore, the controller 3 is capable of discriminating that the waste toner collecting container 10 is not in the near full state. Then, in the case where during the near full state determination time T1 (from a timing t3 to a timing t4), the detecting sensor 131 outputs the ON signal, the controller 3 is capable of discriminating that the waste toner collecting container 10 is in the near full state. Thus, by performing the near full state detection after a lapse of the near full state determination time T1, it is possible to reduce a possibility that exchange warning is notified earlier than an end of an originally determined exchange lifetime, due to detection of the near full state in a state in which the rotational load torque of the fixed gear 122 is not stabilized.

### <Detecting Method of Exchange to New Article>

Next, a detecting method of exchange to a new article, which is a method of detection that the waste toner collecting container 10 (the transfer unit 40 in this embodiment) is exchanged to the new article will be described. Herein, the exchange of the waste toner collecting container 10 (the transfer unit 40 in this embodiment) to the new article (discrimination as to whether or not the waste toner collecting container 10 is exchanged to the new article) is also referred to as “new article exchange detection”.

In this embodiment, the waste toner collecting container 10 is provided in the transfer unit 40, and therefore, the transfer unit 40 is demounted from the apparatus main assembly 1a as shown in FIG. 5, so that the waste toner collecting container 10 can be exchanged to the new article (new waste toner collecting container).

Parts (a), (b) and (c) of FIG. 17 are schematic views, similar to those of parts (a), (b), and (c) of FIG. 12, schematically showing an operation of the drive connection mechanism 120 during the new article exchange detection. Part (a) of FIG. 17 shows a positional relationship between the movable gear 121 and the fixed gear 122. That is, in a new article state of the transfer unit 40, the movable gear 121 and the fixed gear 122 are mounted to the transfer unit 40 so that the second vertical wall portion 121d and the second fixing vertical wall portion 122d are in contact with each other and so that the flat surface portion 121b and the second fixing flat surface portion 122f are in contact with each other. This positional relationship between the movable gear 121 and the fixed gear 122 is held by the action of the urging force of the urging spring 124. When the driving roller 46 starts a rotating operation thereof, the flat surface portion 121b and the second fixing flat surface portion 122f slide relative to each other, so that the movable gear 121 is moved in the arrow R1 direction. When the flat surface portion 121b and the second fixing flat surface portion 122f are separated from each other, as shown in part (b) of FIG. 17, the second inclined surface portion 121e and the second fixing inclined surface portion 122e are in contact with each other, so that the movable gear 121 moves in an urging direction (a direction in which the movable gear 121 approaches the fixed gear 122 along the rotational axis direction of the movable gear 121) of the urging spring 124. Then, as shown in part (c) of FIG. 17, the first inclined surface portion 121a and the first fixing inclined surface portion 122a engage with each other, so that the state of the movable gear 121 and the fixed gear 122 is shifted to the normal state in which the driving force is transmitted from the movable gear 121 to the fixed gear 122.

By using FIG. 18 and parts (a) to (c) of FIG. 19, processing of the new article exchange detection in this embodiment will be described.

FIG. 18 is a flowchart of the detection of the exchange to the new article in this embodiment. Parts (a) and (c) of FIG. 19 are time charts each showing an example of a detection pattern when the new article exchange detection in this embodiment is performed. In this embodiment, the transfer unit 40 is exchanged in a state in which the power source of the printer 1 is turned off (OFF) or in a state in which the door 20 is open. For that reason, in this embodiment, when detection that the power source of the printer 1 is turned on (ON) or that the door 20 is closed is made, the new article exchange detection is performed. In this embodiment, the controller 3 is capable of detecting closing of the door 20 on the basis of a detection signal, indicating an open/close state of the door 20, inputted from a switch (not shown) as an open/close detecting means of the door 20 provided to the printer 1.

When the controller 3 detects that the power source of the printer 1 is turned on or that the door 20 is closed (S201), the controller 3 discriminates whether or not the controller detected an ON signal of the detecting sensor 131 (S202). In the case where the controller 3 detected the ON signal of the detecting sensor 131 (S202: Yes), the controller 3 carries out control so as to actuate the driving motor 5 (S203). Then, the controller 3 discriminates whether or not the controller 3 detected on OFF signal (S204). When the controller detected the OFF signal (S204: Yes), count(ing) of a new article determination time T2 is started, and the controller 3 discriminates whether or not the controller 3 continuously detects the OFF signal during the new article determination time T2 (S204, S205). That is, the controller 3 discriminates whether or not the new article determination time T2 has elapsed in a state in which the controller 3 detects the OFF signal. The new article determination time T2 is set in advance as a time in which the OFF signal such that the transfer unit 40 can be discriminated as the new article with sufficient accuracy. Then, in the case where the controller 3 continuously detected the OFF signal during the new article determination time T2 (S205: Yes), the controller 3 detects that the transfer unit 40 is the new article and executes predetermined processing in the case where the transfer unit 40 is exchanged to the new article (S206). As this predetermined processing, it is possible to cite, for example, that the near full state or the full state is reset (released) and that a lifetime counter of the transfer unit 40 is reset to an initial value (for example, zero). Further, the controller 3 controls the driving motor 5 so as to stop (S207), and ends the new article exchange detection. On the other hand, in the case where the controller 3 does not detect the OFF signal of the detecting sensor 131 in S204 (S204: No), the controller 3 waits a lapse of the new article detection time set in advance (S204, S208), and causes the processing to go to S207, and then ends the new article exchange detection. The new article detection time is set in advance as a time (predetermined period) in which whether or not the transfer unit 40 is the new article can be discriminated with sufficient accuracy (this setting may also be a setting similar to the setting for the above-described near full state determination time T1). This case is a case where the waste toner collecting container 10 is in the near full state or the full state and where the transfer unit 40 is not the new article. Further, in the case where the controller 3 does not detect the ON signal of the detecting sensor 131 in S202 (S202: No), the controller causes the processing to go to S207, and ends the new article exchange detection. This case is a case where the waste toner in the waste toner collecting container 10 is in the normal state in which the amount thereof is less than the predetermined amount and where the transfer unit 40 is not the new article.

Part (a) of FIG. 19 shows the detection pattern immediately after the transfer unit 40 is exchanged to the new article. The detecting sensor 131 outputs the ON signal in the state in which the power source of the printer 1 is turned on, and then outputs the OFF signal substantially at the same time as a drive start timing t5 of the driving roller 46. Thereafter, when the detecting sensor 131 outputs the OFF signal until the new article determination time T2 has elapsed (until a timing t6), the controller 3 is capable of discriminating that the transfer unit 40 is exchanged to the new article. Further, the controller 3 is capable of executing predetermined processing such that the near full state or the full state of the waste toner collecting container 10 is reset.

Part (b) of FIG. 19 shows the detection pattern in the case where the transfer unit 40 in which the waste toner collecting container 10 is in the near full state or the full state is mounted to the apparatus main assembly 1a and where the power source of the printer 1 is turned on or the door 20 is closed. As described above, the drive connection mechanism 120 after the near full state is detected is in the state shown in part (c) of FIG. 12 and is not returned to the state of part (a) of FIG. 12. Accordingly, in the case where the transfer unit 40 after the near full state is detected is mounted to the apparatus main assembly 1a, the detecting sensor 131 always outputs the ON signal. In this case, the controller 3 is capable of discriminating that the waste toner collecting container 10 (transfer unit 40) is not exchanged to the new article.

Part (c) of FIG. 19 shows an example of the detection pattern, for example, in the case where the transfer unit 40 in which the amount of the waste toner in the waste toner collecting container 10 is the vicinity of the predetermined amount.

The detecting sensor 131 outputs the ON signal when the new article exchange detection is started and then outputs the OFF signal (timing t7), but is in a state of detection of the near full state before the new article determination time T2 has elapsed (timing t8), and outputs the ON signal again.

Incidentally, in the case where the transfer unit 40 in which the amount of the waste toner in the waste toner collecting container 10 is less than the predetermined amount is mounted to the apparatus main assembly 1a, the detection pattern is as shown in part (a) of FIG. 15.

That is, on the basis of the detection pattern acquired in the new article exchange detection, the controller 3 is capable of discriminating (detecting) whether or not the transfer unit 40 (waste toner collecting container 10) mounted to the apparatus main assembly 1a is a new transfer unit 40 (new waste toner collecting container 10). Specifically, in this embodiment, on the basis of the detection pattern acquired in the new article exchange detection, the controller 3 is capable of discriminating (detecting) that the transfer unit 40 mounted to the apparatus main assembly 1a is the transfer unit 40 in which the amount of the waste toner in the waste toner collecting container 10 is less than the predetermined amount (normal state), the transfer unit 40 which is the new article (a state in which the waste toner is not accommodated in the waste toner collecting container 10), or the transfer unit 40 in which the amount of the waste toner in the waste toner collecting container 10 is the predetermined amount or more (the near full state or the full state).

Thus, the image forming apparatus (printer 1) includes the apparatus main assembly 1a including the image forming portion (cartridge) P for forming the image with toner, the driving source (driving motor) 5 for generating the driving force, and the detecting portion (detecting mechanism) 100 capable of taking the first state and the second state and for outputting the detection signal depending on each of the first state and the second state; and the exchange unit (transfer unit) 40 mountable to and demountable from the apparatus main assembly 1a and including: the rotatable member (waste toner conveying screw) 113; the first rotatable member (movable gear) 121 for being rotated by input of the driving force from the driving sources thereto; the second rotatable member (fixed gear) 122 provided coaxially with the first rotatable member 121 and configured to transmit the driving force toward the rotatable member 113 by being rotated through transmission thereto the driving force by the first rotatable member 121; and the urging member (urging spring) 124 for urging the first rotatable member 121 against the second rotatable member 122 along a rotational axis direction of the first rotatable member 121. The first rotatable member 121 is movable to the first position (part (a) of FIG. 12, part (c) of FIG. 17) and the second position (part (c) of FIG. 12, part (a) of FIG. 17) different in position thereof relative to the second rotatable member 122 with respect to the rotational axis direction of the first rotatable member 121 in interrelation with a position of the second rotatable member 122 relative to the first rotatable member 121 with respect to the rotational direction of the first rotatable member 121 depending on the magnitude of a rotational load torque of the rotatable member 113, and the detecting portion 100 changes in state between the first state and the second state depending on movement of the first rotatable member 121 between the first position and the second position Further, in this embodiment, the detection pattern of the detection signal outputted by the detecting portion 100 in the predetermined period (new article detection time) from a start of drive of the driving source 5 in a state in which the exchange unit 40 is mounted to the apparatus main assembly 1a is different between the case (normal state) where the first rotatable member 121 is in the first position and the rotational load torque of the rotatable member 113 is less than a predetermined value when the drive of the driving source 5 is started, the case (new article state) where the first rotatable member 121 is in the second position and the rotational load torque of the rotatable member 113 is less than the predetermined value when the drive of the driving source 5 is started, and the case (near full state or full state) where the first rotatable member 121 is in the second position and the rotational load torque of the rotatable member 113 is the predetermined value or more when the drive of the driving source 5 is started.

Further, in this embodiment, the exchange unit 40 includes the waste toner collecting container 10 for accommodating waste toner collected in the apparatus main assembly 1a and the waste toner conveying member (waste toner conveying screw) 113 for conveying the waste toner accommodated in the waste toner collecting container 10, and the rotatable member is the waste toner conveying member 113. Further, in this embodiment, the rotational load torque of the waste toner conveying member 113 is less than the predetermined value in a case where the amount of the waste toner accommodated in the waste toner collecting container 10 is less than the above-described predetermined amount, and is the predetermined value or more in a case where the amount of the waste toner accommodated in the waste toner collecting container 10 is the above-described predetermined amount or more, and the image forming apparatus 1 includes the controller 3 capable of detecting whether or not an amount of the waste toner accommodated in the waste toner collecting container 10 is the above-described predetermined amount or more, on the basis of the detection signal outputted by the detecting portion 100.

Further, in this embodiment, to the exchange unit which is the new article, the first rotatable member 121 is mounted so that the first rotatable member 121 is in the second position before rotation of the rotatable member is started, and on the basis of the detection pattern, the controller 3 is capable of detecting whether or not the exchange unit 40 mounted to the apparatus main assembly 1a is the new article. Further, in this embodiment, in the case where the detection pattern in the case where the first rotatable member 121 is in the second position and the rotational load torque of the rotatable member 113 is less than the above-described predetermined value when the drive of the driving source 5 is started is acquired, the controller 3 detects that the exchange unit 40 mounted to the apparatus main assembly 1a is the new article. Further, in this embodiment, the exchange unit 40 includes the endless belt (intermediary transfer belt) 41 onto which the image formed with the toner by the image forming portion P is transferred, the cleaning portion 43 for removing the toner from the belt 41, and the waste toner collecting container 10 for accommodating the toner removed from the belt 41 by the cleaning portion 43.

Further, in this embodiment, at least one of the first rotatable member 121 and the second rotatable member 122 includes the cam shape portion (first inclined surface portion 121a flat surface portion 121b, first vertical wall portion 121c, first fixing inclined surface portion 122a, first fixing flat surface portion 122b, first fixing vertical wall portion 122_{c}) capable of moving the position of the first rotatable member 121 relative to the second rotatable member 122 with respect to the rotational axis direction of the first rotatable member 121 from the first position to the second position. When the driving source 5 is driven in a state in which the exchange unit 40 is mounted to the apparatus main assembly 1a, the above-described cam shape portion (first inclined surface portion 121a, first fixing inclined surface portion 122a, and the like) is configured so as to maintain the position of the first rotatable member 121 in the first position in the case where the rotational load torque of the rotatable member 113 is less than the predetermined value and so as to maintain the position of the first rotatable member 121 in the second position by moving the position of the first rotatable member 121 from the first position to the second position in the case where the rotational load torque of the rotatable member 113 is changed from the rotational load torque which is less than the predetermined value to the rotational load torque which is the predetermined value or more.

As described above, according to this embodiment, even in the case where for example, the waste toner collecting container 10 is simply mounted or demounted before the near full state is detected, it is possible to properly detect whether or not the waste toner collecting container 10 is exchanged to the new article (new waste toner collecting container). In addition, there is no need that the full state detecting means for the waste toner collecting container 10 and the new article exchange detecting means are separately mounted to the printer, and therefore, a possibility of increases in size and cost of the apparatus due to an increase in number of component parts can be reduced. That is, according to this embodiment, by a simple constitution advantageous in suppression of the increases in size and cost of the apparatus.

### Embodiment 2

Next, another embodiment (embodiment 2) of the present disclosure will be described. Basic constitution and operation of an image forming apparatus of this embodiment are the same as those of the image forming apparatus of the embodiment 1. Accordingly, as regards elements having functions or constitutions identical or corresponding to those of the elements of the image forming apparatus of the embodiment 1, detailed description thereof will be omitted by adding thereto the same reference numerals or symbols as those in the embodiment 1.

### <Drive Transmission Mechanism>

Parts (a) and (b), and (c) and (d) of FIG. 20 are perspective views and front views, respectively, specifically showing the movable gear 221 and the fixed gear 222, respectively, in this embodiment. Part (a) of FIG. 20 is the perspective view showing a surface of the movable gear 221 on the fixed gear 222 side in the rotational axis direction of the movable gear 221, and part (b) of FIG. 20 is the front view showing the surface of the movable gear 221. Part (c) of FIG. 20 is the perspective view showing a surface of the fixed gear 222 on the movable gear 221 side in the rotational axis direction of the fixed gear 222, and part (d) of FIG. 20 is the front view showing the surface of the fixed gear 222. The movable gear 221 and the fixed gear 222 include cam shapes (cam shape portions) engageable with each other.

A drive transmission mechanism 220 in this embodiment includes the movable gear 221 and the fixed gear 222 in this embodiment instead of the movable gear 121 and the fixed gear 122 of the drive connection mechanism 120 in the embodiment 1. In other aspects, a constitution of the drive transmission mechanism 220 is substantially the same as the constitution of the drive connection mechanism 120 in the embodiment 1.

The movable gear 221 rotates in an arrow R1 direction in parts (a) and (b) of FIG. 20. The movable gear 221 includes the cam shape along the rotational direction (circumferential direction) on a surface thereof on the fixed gear 222 side with respect to the rotational axis direction. The movable gear 221 in this embodiment includes a first inclined surface portion 221a, a flat surface portion 221b, and a second inclined surface portion 221c. Of the first inclined surface portion 221a and the second inclined surface portion 221c, the first inclined surface portion 221a is provided on a downstream side of the movable gear 221 with respect to the rotational direction, and the second inclined surface portion 221c is provided on an upstream side of the movable gear 221 with respect to the rotational direction. The first inclined surface portion 221a is inclined with respect to the rotational axis direction of the movable gear 221 so as to approach the fixed gear 222 toward the upstream side of the movable gear 221 with respect to the rotational direction. Further, the second inclined surface portion 221c is inclined with respect to the rotational axis direction of the movable gear 121 so as to be separated from the fixed gear 122 toward the upstream side of the movable gear 221 with respect to the rotational direction.

Further, on a surface of a projected shape portion 221d, on the fixed gear 222 side, where the first inclined surface portion 221a and the second inclined surface portion 221c, are formed. The flat surface portion 221b extends between the first inclined surface portion 221a and the second inclined surface portion 221c along a surface of the movable gear 121 crossing (in this embodiment, substantially perpendicular to) the rotational axis direction of the movable gear 121. Further, the movable gear 221 includes a gear portion 221e at an outer periphery thereof.

The fixed gear 222 rotates in an arrow R2 direction in parts (c) and (d) of FIG. 20. The fixed gear 222 includes the cam shape along the rotational direction (circumferential direction) on a surface thereof on the movable gear 221 side with respect to the rotational axis direction. The fixed gear 222 in this embodiment includes a first fixing inclined surface portion 222a, a fixing flat surface portion 222b, and a second fixing inclined surface portion 222c. Of the first fixing inclined surface portion 222a and the second fixing inclined surface portion 222c, the first fixing inclined surface portion 222a is provided on an upstream side of the fixed gear 222 with respect to the rotational direction, and the second fixing inclined surface portion 222c is provided on a downstream side of the fixed gear 222 with respect to the rotational direction. The first fixing inclined surface portion 222a is inclined with respect to the rotational axis direction of the fixed gear 222 so as to be separated from the movable gear 221 toward the upstream side of the fixed gear 222 with respect to the rotational direction. Further, the second fixing inclined surface portion 222c is inclined with respect to the rotational axis direction of the fixed gear 222 so as to approach the movable gear 221 toward the upstream side of the fixed gear 222 with respect to the rotational direction. Further, on a surface of a fixing projected shape portion 222d, on the movable gear 221 side, where the first fixing inclined surface portion 222a and the second fixing inclined surface portion 222c are formed, a fixing flat surface portion 222b is formed. The fixing flat surface portion 222b extends between the first fixing inclined surface portion 222a and the second fixing inclined surface portion 222c along a surface of the fixed gear 222 crossing (in this embodiment substantially perpendicular to) the rotational axis direction of the fixed gear 222. Further, the fixed gear 222 includes a gear portion 222e at an outer periphery thereof.

That is, the movable gear 221 in this embodiment has a shape such that the first vertical wall portion 121c and the second vertical wall portion 121d (i.e., the projected shape portion 121h) are removed from the movable gear 121 in the embodiment 1. Further, the fixed gear 222 in this embodiment has a shape such that the first fixing vertical wall portion 122c and the second fixing vertical wall portion 122d (i.e., the fixing projected shape portion 122h) are removed from the fixed gear 122 in the embodiment 1.

Incidentally, in this embodiment, the movable gear 221 is provided with a cam shape (portion) which is the same as the above-described cam shape also on an opposite side (in a position shifted by 180 degrees with respect to the rotation direction) with respect to the rotational axis direction of the movable gear 221. Similarly, the fixed gear 222 is provided with a cam shape (portion) which is the same as the above-described can shape also on an opposite side (in a position shifted by 180 degrees with respect to the rotational direction) with respect to the rotational axis direction of the fixed gear 222.

Parts (a), (b), and (c) of FIG. 21 are sectional views in which the cam shapes of the movable gear 221 and the fixed gear 222 are cut at broken line portions in parts (b) and (d) of FIG. 20, and each schematically shows an operation of the drive transmission mechanism 220 during a rotational operation of the driving roller 46.

Similarly as in the embodiment 1, in the normal state, the first inclined surface portion 221a of the movable gear 221 and the first fixing inclined surface portion 222a of the fixed gear 222 are in contact with each other, so that the driving force is transmitted from the movable gear 221 to the fixed gear 222.

When the amount of the waste toner in the waste toner collecting container 10 reaches the predetermined amount, with an increase in rotational load torque of the fixed gear 222, as shown in part (b) of FIG. 21, the first inclined surface portion 221a and the first fixing inclined surface portion 222a slide relative to each other, so that the movable gear 221 moves in a direction (direction in which the movable gear 221 is separated from the fixed gear 222 along the rotational axis direction of the movable gear 221) opposite to the urging direction of the urging spring 124. Thereafter, as shown in part (c) of FIG. 21, a state in which the first inclined surface portion 221a and the first fixing inclined surface portion 222a are separated from each other is formed. Further, a state in which the flat surface portion 221b and the fixing flat surface portion 222b are in contact with each other is formed. When the movable gear 221 is further rotated in the arrow R1 direction from the state of part (c) of FIG. 21, the following movement occurs. That is, as shown in part (d) of FIG. 21, the movable gear 221 moves in the urging direction (direction in which the movable gear 221 approaches the fixed gear 222 along the rotational axis direction of the movable gear 221) of the urging spring 124 while the second inclined surface portion 221c and the second fixing inclined surface portion 222c slide relative to each other. Then, the state of the movable gear 221 and the fixed gear 222 returns to the state of part (a) of FIG. 21.

Thus, in this embodiment, in a state in which the reaction force Ft received by the movable gear depending on a magnitude of the rotational load torque of the fixed gear 122 is smaller than the spring force Fs, as shown in part (a) of FIG. 21, the movable gear 221 and the fixed gear 222 rotate in one direction in an engagement state therebetween. On the other hand, when the reaction force Ft exceeds the spring force Fs, the movable gear 221 is rotated while being moved in the rotational axis direction against the urging force of the urging spring 124. Then, from the state of part (a) of FIG. 21, the state changes in an order of part (b) of FIG. 21, part (c) of FIG. 21, and part (d) of FIG. 21, and returns to the state of part (a) of FIG. 21. This operation is repeated.

Parts (a) and (b) of FIG. 22 are sectional views each showing the detecting mechanism 100 capable of detecting movement of the movable gear 121 in the rotational axis direction in this embodiment. As shown in parts (a) and (b) of FIG. 22, the movable gear 221 and the fixed gear 222 are mounted to the drive transmission mechanism 220. Further, similarly as in the embodiment 1, the detecting lever 123 is moved with movement of the movable gear 221 in the rotational axis direction, and the detecting flag 130 is rotated about the rotation shaft 130a, so that the detecting sensor 131 is put in the state of light blocking or light transmission.

### <Near Full State Detection>

Parts (a) and (b) of FIG. 23 each shows an example of a detection pattern of the detection signal outputted from the detecting sensor 131 when the detecting mechanism 100 in this embodiment detects the near full state (near full state detection). During rotation of the driving roller 46, in a normal state, the detecting sensor 131 outputs an OFF signal. Part (a) of FIG. 23 shows the detection pattern in this case. When the amount of the waste toner in the waste toner collecting container 10 becomes the vicinity of the predetermined amount, by the operation described with reference to parts (a) to (d) of FIG. 21, the detecting sensor 131 alternately outputs the ON signal and the OF signal repetitively. Part (b) of FIG. 23 shows the detection pattern in this case. At this time, depending on a rotational speed of the movable gear 221, the detecting sensor 131 outputs the ON signal and the OFF signal in a predetermined number of times or more in a predetermined time. This predetermined time is referred to as a near full state determination time T3, and the ON signal and the OFF signal are referred to as a pulse signal. A pair of the ON signal and the OFF signal is counted as one (time) in terms of the number of times of pulse signals. The controller 3 detects the pulse signals in a predetermined number of times or more during the near full state determination time T3 (from timing t11 to timing t12), so that the controller 3 is capable of discriminating that the waste toner collecting container 10 is in the near full state. On the other hand, in timings t9 and t10 shown in part (b) of FIG. 23, the detecting sensor 131 outputs the ON signal, but does not detect the pulse signals in the predetermined number of times or more during the near full state determination time T3, and therefore, the controller 3 is capable of discriminating that the waste toner collecting container 10 is not in the near full state. The near full state determination time T3 and the number of times of the pulse signals are set in advance as a time and the number of times by which the controller 3 is capable of discriminating that the waste toner collecting container 10 is in the near full state with sufficient accuracy.

FIG. 24 is a flowchart of the near full state detection in this embodiment. The controller 3 carries out control so as to actuate the driving motor 5, for example, with a start of the image forming operation (S301).

When the controller 3 detects the ON signal of the detecting sensor 131 (S302: Yes), a count of the number of times of the pulse signals is started (S303), and a count of the near full state determination time T3 is started (S304). The controller 3 discriminates whether or not the number of times of the pulse signals is the predetermined number of times or more after a lapse of the near full state determination time T3 (S305). Further, in the case where the number of times of the pulse signals is the predetermined number of times or more (S305: Yes), the controller 3 detects the near full state, and performs near full state notification (S306). Then, the controller 3 carries out control so as to stop drive of the motor 5, for example, with an end of the image forming operation (S307). On the other hand, in the case where the ON signal of the detecting sensor 131 is not detected in S302 (S302: No), and in the case where the number of times of the pulse signals is less than the predetermined number of times in S305(S305: No), the controller 3 causes the processing to go to S307.

Thus, by performing the near full state detection after a lapse of the near full state determination time T3, it is possible to reduce a possibility that exchange warning is notified earlier than an end of an originally determined exchange lifetime, due to detection of the near full state in a state in which the rotational load torque of the fixed gear 222 is not stabilized.

### <New Article Exchange Detection>

Parts (a), (b) and (c) of FIG. 25 are schematic views, similar to those of parts (a), (b), and (c) of FIG. 21, schematically showing an operation of the drive transmission mechanism 220 during the new article exchange detection. Part (a) of FIG. 25 shows a positional relationship between the movable gear 221 and the fixed gear 222. That is, in a new article state of the transfer unit 40, the movable gear 221 and the fixed gear 222 are mounted to the transfer unit 40 so that the flat surface portion 221b and the fixing flat surface portion 222b are in contact with each other. This positional relationship between the movable gear 221 and the fixed gear 222 is held by the action of the urging force of the urging spring 124. When the driving roller 46 starts a rotating operation thereof, the flat surface portion 221b and the fixing flat surface portion 222b slide relative to each other, so that the movable gear 221 is moved in the arrow R1 direction. When the flat surface portion 221b and the fixing flat surface portion 222b are separated from each other, as shown in part (b) of FIG. 25, the second inclined surface portion 221c and the second fixing inclined surface portion 222c are in contact with each other, so that the movable gear 221 moves in an urging direction (a direction in which the movable gear 221 approaches the fixed gear 222 along the rotational axis direction of the movable gear 221) of the urging spring 124. Then, as shown in part (c) of FIG. 25, the first inclined surface portion 221a and the first fixing inclined surface portion 222a engage with each other, so that the state of the movable gear 221 and the fixed gear 222 is shifted to the normal state in which the driving force is transmitted from the movable gear 221 to the fixed gear 222.

By using parts (a) and (b) of FIG. 26 and FIG. 27, processing of the new article exchange detection in this embodiment will be described.

Parts (a) and (c) of FIG. 26 are time charts each showing an example of a detection pattern when the new article exchange detection in this embodiment is performed. FIG. 27 is a flowchart of the detection of the exchange to the new article in this embodiment.

In this embodiment, the transfer unit 40 is exchanged in a state in which the power source of the printer 1 is turned off (OFF) or in a state in which the door 20 is open. For that reason, in this embodiment, when detection that the power source of the printer 1 is turned on (ON) or that the door 20 is closed is made, the new article exchange detection is performed.

When the controller 3 detects that the power source of the printer 1 is turned on or that the door 20 is closed (S401), the controller 3 discriminates whether or not the controller detected an ON signal of the detecting sensor 131 (S402). In the case where the controller 3 detected the ON signal of the detecting sensor 131 (S402: Yes), the controller 3 carries out control so as to actuate the driving motor 5 (S403). Then, the controller 3 discriminates whether or not the controller 3 detected on OFF signal (S404). When the controller detected the OFF signal (S404: Yes), count(ing) of a new article determination time T4 is started, and the controller 3 discriminates whether or not the controller 3 continuously detects the OFF signal during the new article determination time T4 (S404, S405). That is, the controller 3 discriminates whether or not the new article determination time T4 has elapsed in a state in which the controller 3 detects the OFF signal. The new article determination time T4 is set in advance as a time in which the OFF signal such that the transfer unit 40 can be discriminated as the new article with sufficient accuracy. Then, in the case where the controller 3 continuously detected the OFF signal during the new article determination time T4 (S405: Yes), the controller 3 detects that the transfer unit 40 is the new article and executes predetermined processing in the case where the transfer unit 40 is exchanged to the new article (S406). As this predetermined processing, it is possible to cite, for example, that the near full state or the full state is reset (released) and that a lifetime counter of the transfer unit 40 is reset to an initial value (for example, zero). Further, the controller 3 controls the driving motor 5 so as to stop (S407), and ends the new article exchange detection. On the other hand, in the case where the OFF signal of the detecting sensor 131 is not continued during the new article determination time in S404 and S405, the controller 3 waits a lapse of the new article detection time set in advance (S404, S408), and causes the processing to go to S407, and then ends the new article exchange detection. The new article detection time is set in advance as a time in which whether or not the transfer unit 40 is the new article can be discriminated with sufficient accuracy (this setting may also be a setting similar to the setting for the above-described near full state determination time T3). This case is a case where the waste toner collecting container 10 is in the near full state or the full state and where the transfer unit 40 is not the new article. Further, in the case where the controller 3 does not detect the ON signal of the detecting sensor 131 in S402 (S402: No), the controller causes the processing to go to S407, and ends the new article exchange detection. This case is a case where the waste toner in the waste toner collecting container 10 is in the normal state in which the amount thereof is less than the predetermined amount and where the transfer unit 40 is not the new article.

Part (a) of FIG. 26 shows the detection pattern immediately after the transfer unit 40 is exchanged to the new article. The detecting sensor 131 outputs the ON signal in the state in which the power source of the printer 1 is turned on, and then outputs the OFF signal substantially at the same time as a drive start timing t13 of the driving roller 46. Thereafter, when the detecting sensor 131 outputs the OFF signal until the new article determination time T4 has elapsed (until a timing t14), the controller 3 is capable of discriminating that the transfer unit 40 is exchanged to the new article. Further, the controller 3 is capable of executing predetermined processing such that the near full state or the full state of the waste toner collecting container 10 is reset.

Part (b) of FIG. 26 shows the detection pattern in the case where the transfer unit 40 in which the waste toner collecting container 10 is in the near full state or the full state is mounted to the apparatus main assembly 1a and where the power source of the printer 1 is turned on or the door 20 is closed. As described above, the drive transmission mechanism 220 after the near full state is detected repeats the operation from part (a) of FIG. 21 to part (d) of FIG. 21. Accordingly, in the case where the transfer unit 40 after the near full state is detected is mounted to the apparatus main assembly 1a, the detecting sensor 131 repetitively outputs the ON signal and the OFF signal during the new article determination time T4 (from timing t15 to timing t16). In this case, the controller 3 is capable of discriminating that the waste toner collecting container 10 (transfer unit 40) is not exchanged to the new article.

Incidentally, in the case where the transfer unit 40 in which the amount of the waste toner in the waste toner collecting container 10 is less than the predetermined amount is mounted to the apparatus main assembly 1a, the detection pattern is as shown in part (a) of FIG. 23.

That is, similarly as in the embodiment 1, in the new article exchange detection, on the basis of the detection pattern, the controller 3 is capable of discriminating (detecting) whether or not the transfer unit 40 (waste toner collecting container 10) mounted to the apparatus main assembly 1a is a new transfer unit 40 (new waste toner collecting container 10). Specifically, in this embodiment, on the basis of the detection pattern acquired in the new article exchange detection, the controller 3 is capable of discriminating (detecting) that the transfer unit 40 mounted to the apparatus main assembly 1a is the transfer unit 40 in which the amount of the waste toner in the waste toner collecting container 10 is less than the predetermined amount (normal state), the transfer unit 40 which is the new article (a state in which the waste toner is not accommodated in the waste toner collecting container 10), or the transfer unit 40 in which the amount of the waste toner in the waste toner collecting container 10 is the predetermined amount or more (the near full state or the full state). Incidentally, in this embodiment, in the new article exchange detection, in the case where the waste toner collecting container 10 is in the near full state or the full state, when the drive of the driving motor 5 is started, in addition to the case where the movable gear 121 is in the second position (part (c) of FIG. 21), it is possible that there is also the case where the movable gear 121 is in the first position (part (a) of FIG. 21). However, also in the case where the movable gear 121 is in the first position at the time of the start of the new article exchange detection as described above, thereafter, in the new article exchange detection, the movable gear 121 repetitively moves to the second position and the first position, so that the detection signal repeats the ON signal and the OFF signal. For that reason, also in this case, the controller 3 is capable of detecting that the transfer unit 40 mounted to the apparatus main assembly 1a is the transfer unit 40 in which the waste toner collecting container 10 is in the near full state or the full state.

Thus, in this embodiment, at least one of the first rotatable member (movable gear) 221 and the second rotatable member (fixed gear) 222 includes the cam shape portion (first inclined surface portion 221a, flat surface portion 221b, second inclined surface portion 221c, first fixing inclined surface portion 222a, fixing flat surface portion 222b, second fixing inclined surface portion 222c) capable of moving the position of the first rotatable member 221 relative to the second rotatable member 222 with respect to the rotational axis direction of the first rotatable member 221 from the first position (part (a) of FIG. 21) to the second position (part (c) of FIG. 21). When the driving source 5 is driven in a state in which the exchange unit 40 is mounted to the apparatus main assembly 1a, the above-described cam shape portion (first inclined surface portion 221a, first fixing inclined surface portion 222a, and the like) is configured so as to maintain the position of the first rotatable member 121 in the first position in the case where the rotational load torque of the rotatable member 113 is less than the predetermined value and so as to repeat movement of the position of the first rotatable member 221 from the first position to the second position and from the second position to the first position in the case where the rotational load torque of the rotatable member 113 is changed from the rotational load torque which is less than the predetermined value to the rotational load torque which is the predetermined value or more.

As described above, also by the constitution of this embodiment, it is possible to obtain an effect similar to the effect of the embodiment 1.

### Other Embodiments

In the above, the present disclosure was described based on specific embodiments, but the present disclosure is not limited to the above-described embodiments.

In the above-described embodiments, the case where the example unit is the waste toner collecting container was described as an example, but the exchange unit is not limited thereto. For example, also, as regards a toner conveying screw of a supplying device for supplying the toner to the developing device and a process means such as the developing roller of the developing device, it is desired in some instances that the overload state thereof is detected. Further, it is also desired in some instances that as regards these means, whether or not these means are new articles is detected. The present disclosure is also applicable to such other exchange units.

Further, the waste toner is not limited to the waste toner remaining on the image bearing member after the transfer step. For example, in the image forming apparatus, an operation in which in order to refresh the developer in the developing device, the toner (developer containing toner and a carrier in the case of a two-component developer) is discharged from the developing device is performed in some instances. Further, a toner image (patch) for adjustment which is not transferred onto a recording material is formed on the image bearing member in some instances. The waste toner accommodated in the waste toner collecting container contains the above-described arbitrary toner (which may contain the carrier). Further, the toner removed from the image bearing member is not limited to the toner removed from the intermediary transfer belt, but may also include the toner removed from the photosensitive drum.

Further, in the above-described embodiments, description was made such that the state in which the rotational load torque of the waste toner conveying screw is the predetermined value or more is the near full state of the waste toner collecting container, but for example, the state may also be the full state of the waste toner collecting container.

Further, in the above-described embodiments, description was made such that to the waste toner conveying screw, the driving force from the driving source for rotationally driving the belt (driving roller), but the image forming apparatus may include an individual driving source for rotationally driving the waste toner conveying screw.

Further, in the above-described embodiments, the case where as the detecting sensor, the photosensor is used was described as an example, but as the detecting sensor, for example, a mechanical switch which is turned on/off by a flag may also be used.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-152771, filed on Sep. 4, 2024, which is hereby incorporated by reference herein in its entirety.

What is claimed is:

1. An image forming apparatus comprising:
a main assembly including an image forming portion configured to form an image with toner, a driving source configured to generate a driving force, and a detecting portion capable of taking a first state and a second state and configured to output a detection signal depending on each of the first state and the second state; and
an exchange unit detachably mountable to the main assembly and including:
a rotatable member;
a first rotatable member configured to be rotated by input of the driving force from the driving source thereto;
a second rotatable member provided coaxially with the first rotatable member and configured to transmit the driving force toward the rotatable member by being rotated through transmission thereto the driving force by the first rotatable member; and
an urging member configured to urge the first rotatable member against the second rotatable member along a rotational axis direction of the first rotatable member,
wherein the first rotatable member is movable to a first position and a second position different in position thereof relative to the second rotatable member with respect to the rotational axis direction of the first rotatable member in interrelation with a position of the second rotatable member relative to the first rotatable member with respect to a rotational direction of the first rotatable member depending on a magnitude of a rotational load torque of the rotatable member,
wherein the detecting portion changes in state between the first state and the second state depending on movement of the first rotatable member between the first position and the second position, and
wherein a detection pattern of a detection signal outputted by the detecting portion in a predetermined period from a start of drive of the driving source in a state in which the exchange unit is mounted to the main assembly is different between a case where the first rotatable member is in the first position and the rotational load torque of the rotatable member is less than a predetermined value when the drive of the driving source is started, a case where the first rotatable member is in the second position and the rotational load torque of the rotatable member is less than the predetermined value when the drive of the driving source is started, and a case where the first rotatable member is in the second position and the rotational load torque of the rotatable member is the predetermined value or more when the drive of the driving source is started.

2. The image forming apparatus according to claim 1, wherein the exchange unit includes a waste toner collecting container for accommodating waste toner collected in the main assembly and a waste toner conveying member for conveying the waste toner accommodated in the waste toner collecting container, and
wherein the rotatable member is the waste toner conveying member.

3. The image forming apparatus according to claim 2, further comprising a controller capable of detecting whether or not an amount of the waste toner accommodated in the waste toner collecting container is a predetermined amount or more, on the basis of the detection signal outputted by the detecting portion,
wherein the rotational load torque of the waste toner conveying member is less than the predetermined value in a case where the amount of the waste toner accommodated in the waste toner collecting container is less than the predetermined amount, and is the predetermined value or more in a case where the amount of the waste toner accommodated in the waste toner collecting container is the predetermined amount or more.

4. The image forming apparatus according to claim 3, wherein to the exchange unit which is a new article, the first rotatable member is mounted so that the first rotatable member is in the second position before rotation of the rotatable member is started, and
wherein on the basis of the detection pattern, the controller is capable of detecting whether or not the exchange unit mounted to the main assembly is the new article.

5. The image forming apparatus according to claim 4, wherein in a case where the detection pattern in the case where the first rotatable member is in the second position and the rotational load torque of the rotatable member is less than the predetermined value when the drive of the driving source is started is acquired, the controller detects that the exchange unit mounted to the main assembly is the new article.

6. The image forming apparatus according to claim 2, wherein the exchange unit includes
an endless belt onto which the image formed with the toner by the image forming portion is transferred,
a cleaning portion for removing the toner from the belt, and
the waste toner collecting container for accommodating the toner removed from the belt by the cleaning portion.

7. The image forming apparatus according to claim 1, wherein at least one of the first rotatable member and the second rotatable member includes a cam shape portion capable of moving the position of the first rotatable member relative to the second rotatable member with respect to the rotational axis direction of the first rotatable member from the first position to the second position.

8. The image forming apparatus according to claim 7, wherein when the driving source is driven in a state in which the exchange unit is mounted to the main assembly, the cam shape portion is configured so as to maintain the position of the first rotatable member in the first position in a case where the rotational load torque of the rotatable member is less than the predetermined value and so as to maintain the position of the first rotatable member in the second position by moving the position of the first rotatable member from the first position to the second position in a case where the rotational load torque of the rotatable member is changed from the rotational load torque which is less than the predetermined value to the rotational load torque which is the predetermined value or more.

9. The image forming apparatus according to claim 7, wherein when the driving source is driven in a state in which the exchange unit is mounted to the main assembly, the cam shape portion is configured so as to maintain the position of the first rotatable member in the first position in a case where the rotational load torque of the rotatable member is less than the predetermined value and so as to repeat movement of the position of the first rotatable from the first position to the second position and movement of the position of the first rotatable member from the second position to the first position in a case where the rotational load torque of the rotatable member is changed from the rotational load torque which is less than the predetermined value to the rotational load torque which is the predetermined value or more.
